(19) United States
(12) Patent Application Publication
(10) Pub. No.: US 2008/0238957 A1
(43) Pub. Date: Oct. 2, 2008

(54) Functional liquid supplying apparatus, liquid droplet ejection apparatus, method for manufacturing electro-optical apparatus, electro-optical apparatus, and electronic apparatus

(75) Inventor: Takayuki Hayashi, Shimosuwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/077,708

(22) Filed: Mar. 20, 2008

(30) Foreign Application Priority Data
Mar. 29, 2007 (JP) 2007-089250

(51) Int. Cl. B41J 2/175; B41J 2/195; B41J 2/19

(52) U.S. Cl. 347/7; 347/85; 347/92

(57) ABSTRACT

Provided herein is a functional liquid supplying apparatus including sub-tanks which supply functional liquid through head-side channels to inkjet functional liquid droplet ejection heads, a main tank which supplies the functional liquid to the sub-tanks by applying a pressure, a functional liquid channel including a main channel connected to the main tank, a branched channel connected to the main channel, and branch channels connected to the branched channel and connected to the corresponding sub-tanks, a buffer tank arranged in the main channel, an auxiliary pressure applying unit used to supply the functional liquid in the buffer tank to the sub-tanks by applying a pressure when the main tank is replaced, and branch channel opening units which are disposed in the branch channels and which supply the functional liquid supplied by applying a pressure from the main tank or the buffer tank to the sub-tanks by performing opening/closing operations.

The entire disclosure of Japanese Patent Application No. 2007-089249, filed Mar. 29, 2007, is expressly incorporated by reference herein.

### BACKGROUND

1. Technical Field

The present invention relates to functional liquid supplying apparatuses which supply functional liquid to functional liquid droplet ejection heads of liquid droplet ejection apparatuses, the liquid droplet ejection apparatuses, methods for manufacturing electro-optical apparatuses, the electro-optical apparatuses, and electronic apparatuses.

2. Related Art

In general, a known functional liquid supplying apparatus includes sub-tanks which store functional liquid to be supplied to functional liquid droplet ejection heads, a single main tank which supplies functional liquid to the sub-tanks, ink tubes which connect the functional liquid droplet ejection heads, the sub-tanks, and the main tank one another, and a liquid supplying unit which supplies the functional liquid from the main tank through the sub-tanks to the functional liquid droplet ejection heads and which controls a supply operation of the functional liquid (refer to JP-A-11-42771). When the functional liquid is ejected as functional liquid droplets from the functional liquid droplet ejection heads and the functional liquid stored in the sub-tanks is reduced, the functional liquid stored in the main tank is supplied to the sub-tanks.

In such a functional liquid supplying apparatus, however, an amount of the functional liquid included in the main tank may be reduced while the main tank receives functional liquid requiring signals from the sub-tanks, and therefore, the main tank should be changed to a new one. In this case, if a plotting process is continued, the functional liquid in the sub-tanks may run out and the functional liquid droplet ejection heads may continue an ejecting process without the functional liquid. Therefore, the plotting process should be stopped and the main tank should be changed to a new one. Accordingly, with this configuration, since when the main tank is changed to a new one, the plotting process should be stopped, the productivity is degraded.

### SUMMARY

An advantage of some aspects of the invention is that there is provided a functional liquid supplying apparatus which does not require stop of a plotting process performed using functional liquid droplet ejection heads when a main tank is changed to a new one, a liquid droplet ejection apparatus, a method for manufacturing an electro-optical apparatus, the electro-optical apparatus, and an electronic apparatus.

According to an embodiment of the invention, there is provided a functional liquid supplying apparatus including a plurality of sub-tanks which supply functional liquid through head-side channels to a plurality of inkjet functional liquid droplet ejection heads, a main tank which supplies the functional liquid to the plurality of sub-tanks by applying a pressure, a functional liquid channel including a main channel connected to the main tank at an upstream end thereof, a branched channel connected to the main channel at an upstream end thereof, and a plurality of branch channels connected to the branched channel at upstream ends thereof and connected to the corresponding sub-tanks at downstream ends thereof, a buffer tank arranged in the main channel, an auxiliary pressure applying unit which is used to supply the functional liquid in the buffer tank to the sub-tanks by applying a pressure when the main tank is changed to a new one, and a plurality of branch channel opening units which are disposed in the respective branch channels and which supply the functional liquid supplied by applying a pressure from the main tank or the buffer tank to the sub-tanks by performing opening/closing operations.

With this configuration, when the functional liquid in the main tank runs out, functional liquid included in the buffer tank is supplied to the sub-tanks using the auxiliary pressure applying unit and the branch channel opening units. Accordingly, the functional liquid is continuously supplied to the sub-tanks while the main tank is changed to a new one. Consequently, it is not necessary to stop a plotting process using the functional liquid droplet ejection heads, and hence the productivity is improved.

The branch channel opening units may be air-operated valves openable and closable without volumetric changes of the branch channels.

With this configuration, pulsations of the functional liquid generated when the branch channel opening units are opened or closed are suppressed. Accordingly, the pulsations are prevented from being transmitted to the functional liquid droplet ejection heads and ejection defects of the functional liquid droplet ejection heads are suppressed. Furthermore, since the air-operated valves are employed, the temperature of the functional liquid passing through valves is prevented from increasing.

The sub-tanks may be disposed in positions higher than the corresponding functional liquid droplet ejection heads. Pressure reducing valves which operate in accordance with an atmospheric pressure and which maintain hydraulic head values between the pressure reducing valves and the functional liquid droplet ejection heads within a predetermined allowable range may be arranged in the respective head-side channels. Negative pressure controllers which maintain hydraulic head values between the negative pressure controllers and the corresponding pressure reducing valves within a predetermined allowable range may be connected to the sub-tanks.

With this configuration, since the pressure reducing valves and the negative pressure controllers are employed, a hydraulic head value of the functional liquid at a nozzle surface of the functional liquid droplet ejection heads is accurately controlled. Furthermore, since the difference between a liquid level when each of the sub-tanks is full and a liquid level when the functional liquid is determined to be a low level is large, capacity of each of the sub-tanks may become smaller.

The functional liquid supplying apparatus may further include liquid level controllers which control levels of liquid to stay around intermediate portions of the sub-tanks when the functional liquid is supplied to the sub-tanks.

With this configuration, a large space (gas capacity) which is not filled with the functional liquid is normally maintained in each of the sub-tanks. With this configuration, pulsations of the functional liquid generated upstream of the sub-tanks are absorbed, and ejection defects of the functional liquid droplet ejection heads are suppressed.

The functional liquid supplying apparatus may further include a bubble removing unit which is disposed in the main channel and which removes microbubbles from the functional liquid.

With this configuration, the generation of comparatively large bubbles such as microbubbles in the functional liquid is suppressed. Accordingly, the functional liquid including the bubbles is prevented from being supplied to the sub-tanks, and error detection of a liquid level due to the bubbles in each of the sub-tanks is avoided. Since the detection of the liquid level is precisely performed, a hydraulic head value of the functional liquid is properly maintained, and therefore, ejection defects of the functional liquid droplet ejection heads are suppressed.

The functional liquid supplying apparatus may further include an air releasing unit disposed at a downstream end of the main channel, and an air releasing channel connected to the air releasing unit.

With this configuration, the air releasing unit enables appropriate release of unnecessary air when the functional liquid is initially filled into each of the functional liquid supplying apparatuses. That is, unnecessary air is readily eliminated when the functional liquid is initially filled into the functional liquid supplying apparatuses.

The functional liquid supplying apparatus may further include sub pressure units which are connected to the sub-tanks and which apply pressures to the sub-tanks, head channel opening units which disposed in the head-side channels and which open and close the head-side channels, upper limit detectors which detect levels of liquid which have reached upper limits of the sub-tanks, and liquid supply controllers which control the sub pressure units, the branch channel opening units, and the head channel opening units. When the upper limit detectors detect the levels of liquid which has reached the upper limits of the sub-tanks, the liquid supply controllers may open the branch channel opening units and close the head channel opening units, and thereafter, drive the sub pressure units so that the functional liquid included in the sub-tanks are reversely supplied to the buffer tank.

With this configuration, in a case where an excessive amount of functional liquid is supplied to the sub-tanks, the supplied functional liquid is reversely supplied so that part of the functional liquid is supplied to the buffer tank. By appropriately performing the reverse supply operation, the functional liquid is prevented from being oversupplied to the sub-tanks 121 and being discarded, and it is not necessary to stop operation of the

The branched channel may be configured such that, a channel is repeatedly divided into two channels in a plurality of stages from an upstream end thereof to a downstream end thereof using branched joints and pairs of connection short tubes, and may be disposed such that the upstream end thereof is positioned in a lower side and the downstream end thereof is positioned in an upper side.

With this configuration, a complicated configuration configured for obtaining fixed pressure losses and flow rates can be eliminated, and a simply branched structure is attained. Since the upstream end of the branched channel is positioned in the lower side and the downstream end of the branched channel is positioned in the upper side and therefore the functional liquid flows from the lower side to the upper side, air is prevented from remaining in the branched channel.

When a branched channel, the number of ends of which is not any power of two in a most downstream stage is employed, pressure losses may be controlled by controlling lengths of the pairs of connection short tubes in the most downstream stage and the pairs of connection short tubes in a stage one stage higher than the most downstream stage.

With this configuration, when a branched channel, the number of ends of which is not any power of two in a most downstream stage, is employed, pressure losses may be controlled by controlling lengths of the tubes. Accordingly, even when a branched channel, the number of ends of which is not any power of two in a most downstream stage, is employed, identical amounts of the functional liquid are supplied to the sub-tanks.

In the branched channel, among the branched joints and the pairs of connection short tubes, branched joints and pairs of connection short tubes in the most upstream stage may have diameters larger than at least those of branched joints and pairs of connection short tubes in the most downstream stage.

With this configuration, a pressure loss of the branched channel is reduced as much as possible.

The branched joints may be T-shaped joints.

With this configuration, an inexpensive branched channel is obtained by employing inexpensive T-shaped joints.

According to another embodiment of the invention, there is provided a liquid droplet ejection apparatus, including a plotting unit which performs a plotting process by ejecting functional liquid droplets from inkjet functional liquid droplet ejection heads while the inkjet functional liquid droplet ejection heads are moved, and the functional liquid supplying apparatus which supplies functional liquid to the functional liquid droplet ejection heads.

With this configuration, since the main tank is changed to a new one without stopping operation of the liquid droplet ejection apparatus, the productivity of the apparatus is improved. Note that when the plotting process is performed using functional liquids of three colors R, G, and B, three functional liquid supplying apparatuses may be provided.

The liquid droplet ejection apparatus may further includes a chamber unit configured to control inner atmosphere at a predetermined temperature. The chamber unit may accommodate the plotting unit and further accommodate the functional liquid supply apparatus but may not accommodate the main tank which is arranged outside the chamber unit.

With this configuration, since the main tank may be replaced without opening the chamber unit, the productivity of the apparatus is further improved.

According to a further embodiment of the invention, there is provided a method for manufacturing an electro-optical apparatus, wherein a film formation portion may be formed on a workpiece by functional liquid droplets using the liquid droplet ejection apparatus.

According to a still further embodiment of the invention, there is provided an electro-optical apparatus in which a film formation portion is formed on a workpiece by functional liquid droplets using the liquid droplet ejection apparatus.

With this configuration, a high-quality electro-optical apparatus is efficiently manufactured. Note that, examples of functional material include, in addition to a light-emitting material (an light-emitting layer, and a hole-injecting layer) for organic EL (electro-luminescence) devices, filter material (filter elements) for color filters employed in liquid crystal display devices, fluorescent material (phosphor) for field emission display (FED) devices, fluorescent material (phosphor) for plasma display panel (PDP) devices, and electrophoretic material (electrophoresis) for electrophoretic display devices, which are allowed to be ejected from the functional liquid droplet ejection heads (inkjet heads). Furthermore, examples of the electro-optical apparatus (that is, flat panel display (FPD) devices) include an organic EL device, a liquid crystal display device, a field emission display device, a plasma display panel device, and an electrophoretic display device.

According to a yet further embodiment of the invention, there is provided an electronic apparatus provided with the electro-optical apparatus manufactured by the method for manufacturing an electro-optical apparatus.

Examples of the electronic apparatus include a cellular phone, a personal computer, and various electronic products, in which flat panel display devices are disposed thereon.

### BRIEF DESCRIPTION OF THE DRAWINGS

The invention will be described with reference to the accompanying drawings, wherein like numbers reference like elements.

FIG. 1 is a perspective view illustrating a liquid droplet ejection apparatus according to an embodiment of the invention.

FIG. 2 is a plan view illustrating the liquid droplet ejection apparatus.

FIG. 3 is a side view of the liquid droplet ejection apparatus.

FIG. 4 is a diagram illustrating functional liquid droplet ejection heads including head groups.

FIG. 5 is a perspective view of an appearance of one of the functional liquid droplet ejection heads.

FIG. 6 is a diagram illustrating a piping system of a functional liquid supplying apparatus.

FIGS. 7A and 7B are diagrams illustrating a tank cabinet.

FIG. 8A is a diagram illustrating an eight-branched channel.

FIG. 8B is a diagram illustration of a ten-branched channel as a modification of the eight-branched channel.

FIG. 9 is a sectional view schematically illustrating a sub-tank and the vicinity thereof.

FIG. 10 is a block diagram illustrating a main control system of the liquid droplet ejection apparatus.

FIG. 11 is a flow chart illustrating manufacturing steps of the color filter.

FIGS. 12A to 12E are sectional views schematically illustrating the color filter showing in an order of manufacturing steps.

FIG. 13 is a sectional view schematically illustrating an essential part of a first liquid crystal display apparatus employing the color filter according to an embodiment of the invention.

FIG. 14 is a sectional view schematically illustrating an essential part of a second liquid crystal display apparatus employing the color filter according to an embodiment of the invention.

FIG. 15 is a sectional view schematically illustrating an essential part of a third liquid crystal display apparatus employing the color filter according to an embodiment of the invention.

FIG. 16 is a sectional view illustrating an essential part of an organic EL display apparatus.

FIG. 17 is a flowchart illustrating manufacturing steps of the organic EL display apparatus.

FIG. 18 is a process chart illustrating formation of an inorganic bank layer.

FIG. 19 is a process chart illustrating formation of an organic bank layer.

FIG. 20 is a process chart illustrating processes of forming a positive-hole injection/transport layer.

FIG. 21 is a process chart illustrating a state where the positive-hole injection/transport layer has been formed.

FIG. 22 is a process chart illustrating processes for forming a light-emitting layer having a blue color component.

FIG. 23 is a process chart illustrating a state where the light-emitting layer having a blue color component has been formed.

FIG. 24 is a process chart illustrating a state where light-emitting layers having three color components have been formed.

FIG. 25 is a process chart illustrating processes for forming a cathode.

FIG. 26 is a perspective view illustrating an essential part of a plasma display apparatus (PDP apparatus).

FIG. 27 is a sectional view illustrating an essential part of an electron emission display apparatus (FED apparatus).

FIG. 28A is a plan view illustrating an electron emission portion and the vicinity thereof of a display apparatus, and FIG. 28B is a plan view illustrating a method of forming the electron emission portion and the vicinity thereof.

### DESCRIPTION OF EXEMPLARY EMBODIMENTS

A liquid droplet ejection apparatus employing functional liquid supplying apparatuses according to the invention will be described hereinafter with reference to the accompanying drawings. The liquid droplet ejection apparatus is used in a production line of a flat panel display device. For example, the liquid droplet ejection apparatus employs functional liquid droplet ejection heads using special ink or functional liquid such as luminescent resin liquid to form light-emitting elements serving as pixels of a color filter of a liquid crystal display device or an organic EL device.

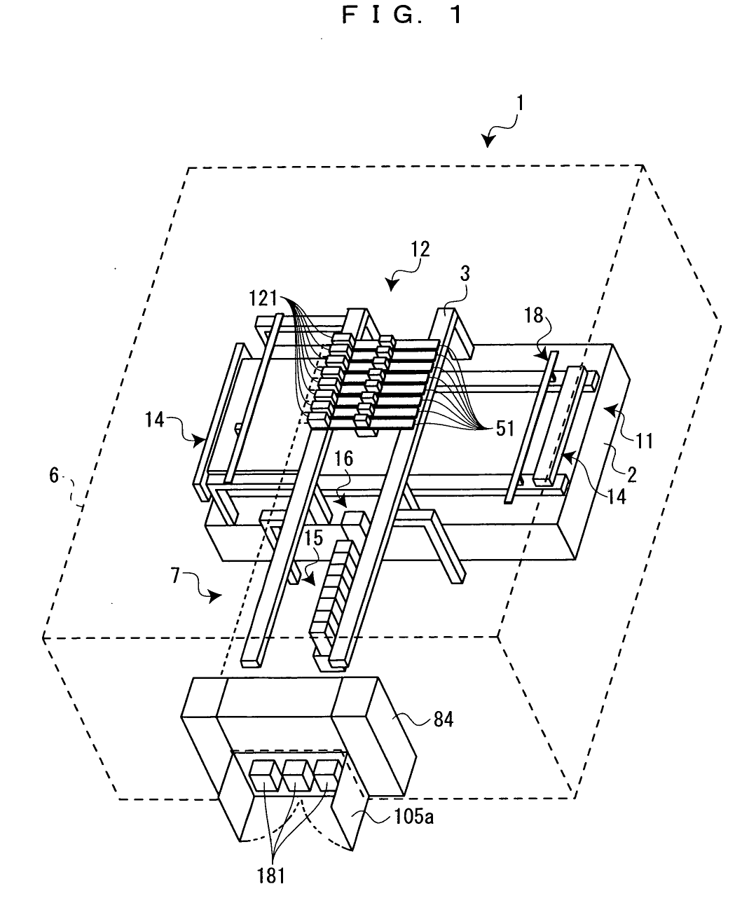

As shown in FIGS. 1, 2, and 3, a liquid droplet ejection apparatus 1 includes an X-axis table 11, a Y-axis table 12, and eight carriage units 51. The X-axis table 11 is disposed on an X-axis supporting base 2 mounted on a stone surface plate, extends in an X-axis direction which is a main scanning direction, and moves a workpiece W in the X-axis direction (main scanning direction). The Y-axis table 12 is disposed on a pair of (two) Y-axis supporting bases 3 which is arranged so as to stride across the X-axis table 11 using a plurality of poles 4, and extends in a Y-axis direction which is a sub-scanning direction. The eight carriage units 51 include a plurality of functional liquid droplet ejection heads 17 (not shown) mounted thereon, and are arranged so as to be hanged from the Y-axis table 12. The liquid droplet ejection apparatus 1 includes a chamber 6 which accommodates these components under the atmosphere of proper temperature and humidity and a functional liquid supplying unit 7 including three functional liquid supplying apparatuses 101 which supply functional liquid from the outside of the chamber 6 through the chamber 6 to the functional liquid droplet ejection heads 17 inside the chamber 6. The functional liquid droplet ejection heads 17 are driven to perform an ejection operation in synchronization with driving operations of the X-axis table 11 and the Y-axis table 12 whereby functional liquid droplets of three colors, R, G, and B are ejected and a predetermined plotting pattern is printed on the workpiece W.

The liquid droplet ejection apparatus 1 further includes a maintenance unit 5 having a flushing unit 14, a suction unit 15, a wiping unit 16, and an ejection function inspection unit 18 which are used for maintenance of the functional liquid droplet ejection heads 17 so that functional maintenance and functional recovery of the functional liquid droplet ejection heads 17 are achieved. Note that, among the units included in the maintenance unit 5, the flushing unit 14 and the ejection function inspection unit 18 are mounted on the X-axis table 11, the suction unit 15 and the wiping unit 16 extend orthogonally to the X-axis table 11 and are disposed on a mounting portion located in a position in which the suction unit 15 and the wiping unit 16 do not disturb movement of the carriage units 51 moved using the Y-axis table 12. Note that, specifically, the ejection function inspection unit 18 has a stage unit 77 disposed on the X-axis table 11 and a camera unit 78 disposed on a Y-axis base 3, which will be described hereinafter.

The flushing unit 14 includes a pair of pre-plotting flushing units 71 and a periodic flushing unit 72, and receives functional liquid ejected from the functional liquid droplet ejection heads 17 at a time of pre-plotting flushing which is performed immediately before the functional liquid is ejected onto the workpiece W and which is performed when a plotting process is temporarily stopped, for example, during a replacement operation of the workpiece W. The suction unit 15 includes a plurality of divided suction units 74, forcedly sucks the functional liquid from ejection nozzles 98 of the functional liquid droplet ejection heads 17 (hereinafter referred to as a “sucking operation”), and performs capping. The wiping unit 16 includes a wiping sheet 75 and wipes nozzle surfaces 97 of the functional liquid droplet ejection heads 17 after the sucking operation is performed. The ejection function inspection unit 18 includes the stage unit 77 and the camera unit 78, and inspects ejection functions (whether the ejection operation is properly performed and whether the functional liquid is ejected straight) of the functional liquid droplet ejection heads 17. The stage unit 77 includes an inspection sheet 83 mounted thereon which receives functional liquid droplets ejected from the functional liquid droplet ejection heads 17. The camera unit 78 is used to inspect the functional liquid droplets received using the stage unit 77 by recognizing an image.

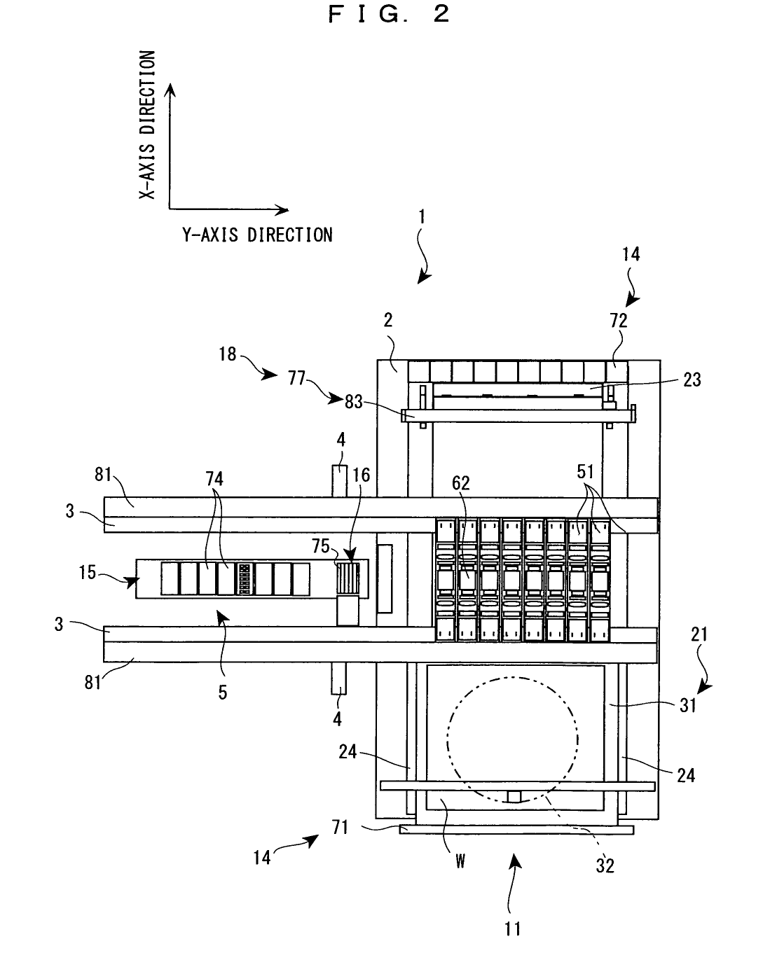

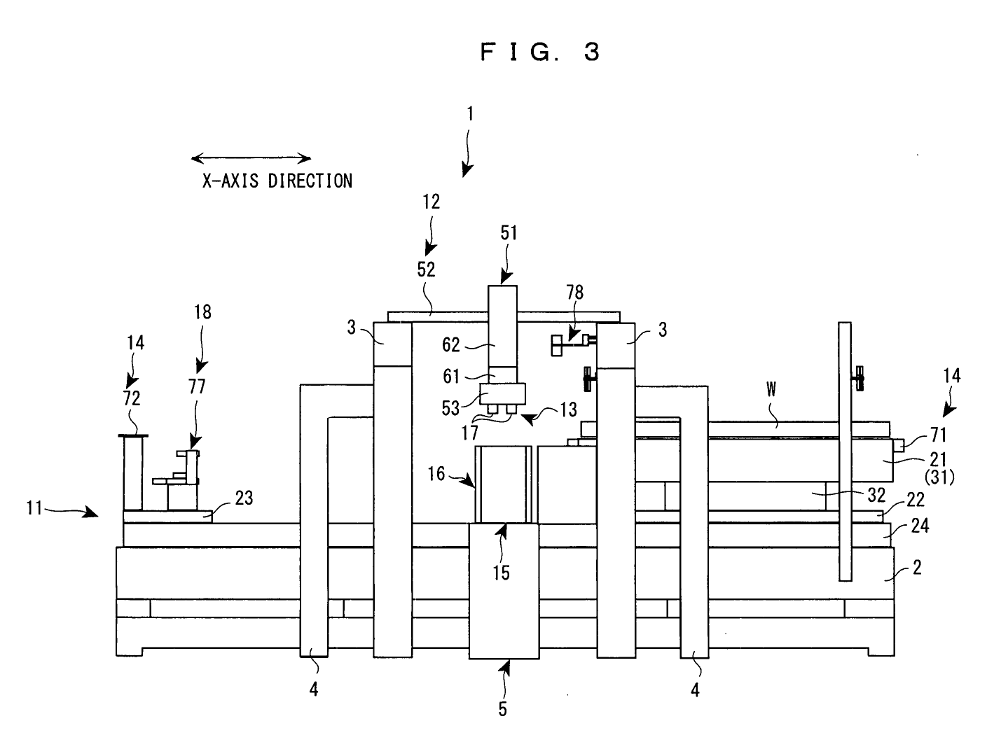

Components of the liquid droplet ejection apparatus 1 will be described hereinafter. As shown in FIGS. 2 and 3, the X-axis table 11 includes a set table 21, an X-axis first slider 22, an X-axis second slider 23, a pair of right and left X-axis linear motors (not shown), and a pair of (two) X-axis common supporting bases 24. The set table 21 is used to set a workpiece W. The X-axis first slider 22 is used to support the set table 21 to slide in the X direction. The X-axis second slider 23 is used to support the flushing unit 14 and the stage unit 77 to slide in the X-axis direction. The pair of X-axis linear motors extends in the X-axis direction, is used to move the set table 21 (workpiece W) in the X-axis direction through the X-axis first slider 22, and is used to move the flushing unit 14 and the stage unit 77 in the X-axis direction through the X-axis second slider 23. The pair of X-axis common supporting bases 24 is arranged so as to be parallel to the X-axis linear motors and guides the X-axis first slider 22 and the X-axis second slider 23.

The set table 21 includes a suction table 31 for attracting the workpiece W to be set thereto and a θ table 32 for correcting a position of the workpiece W set on the suction table 31 in a θ-axis direction. Furthermore, the pre-plotting flushing units 71 are additionally provided on a pair of sides of the set table 21 which is parallel to the Y-axis direction.

The Y-axis table 12 includes eight bridge plates 52 in which the eight carriage units 51 are hanged, respectively, and eight pairs of Y-axis sliders (not shown) which support the corresponding eight bridge plates 52 at both sides thereof. In addition, the Y-axis table 12 includes a pair of Y-axis linear motors (not shown) which are disposed on the pair of Y-axis supporting bases 3 and which are used to move the eight bridge plates 52 in the Y-axis direction through the eight pairs of Y-axis sliders. The Y-axis table 12 sub-scans the functional liquid droplet ejection heads 17 through the eight carriage units 51 at a time of the plotting process, and controls the functional liquid droplet ejection heads 17 to face the maintenance unit 5 (the suction unit 15 and the wiping unit 16).

When the pair of linear motors is (simultaneously) driven, the Y-axis sliders simultaneously move in parallel to the Y-axis direction with the pair of Y-axis supporting bases 3 as guides. Therefore, the bridge plates 52 move in the Y-axis direction along with the carriage units 51 (sub-scanning). In this case, each of the carriage units 51 may independently move by drive-controlling the Y-axis linear motors, or the eight carriage units 51 may integrally move.

Cable supporting members 81 are disposed on the both sides of the Y-axis table 12 so as to be parallel to the Y-axis table 12. Each of the cable supporting members 81 has one end fixed to the Y-axis base 3 and the other end fixed to corresponding sides of the eight bridge plates 52. Each of the cable supporting members 81 accommodates cables, air tubes and functional liquid channel (functional liquid downstream channels 127, which will be described hereinafter) for the eight carriage units 51.

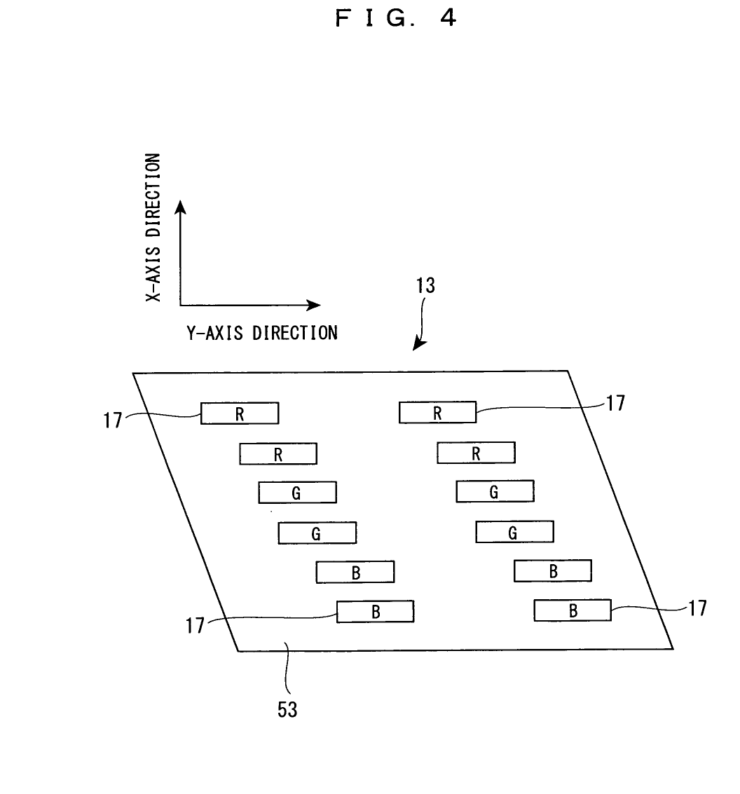

Each of the carriage units 51 includes a head unit 13 having 12 functional liquid droplet ejection heads 17 and a carriage plate 53 in which the 12 functional liquid droplet ejection heads 17 are arranged thereon so as to be divided into two groups each of which has six functional liquid droplet ejection heads 17 (refer to FIG. 4). Furthermore, each of the carriage units 51 has a θ rotation mechanism 61 which supports the head unit 13 so that the head unit 13 is subjected to θ correction (θ rotation), and a hanging member 62 which supports the head unit 13 on the Y-axis table 12 (a corresponding one of the bridge plates 52). In addition, sub-tanks 121 are disposed on the respective carriage units 51 (specifically, the sub-tanks 121 are disposed on the bridge plates 52), and functional liquid is supplied from the sub-tanks 121 to the functional liquid droplet ejection heads 17.

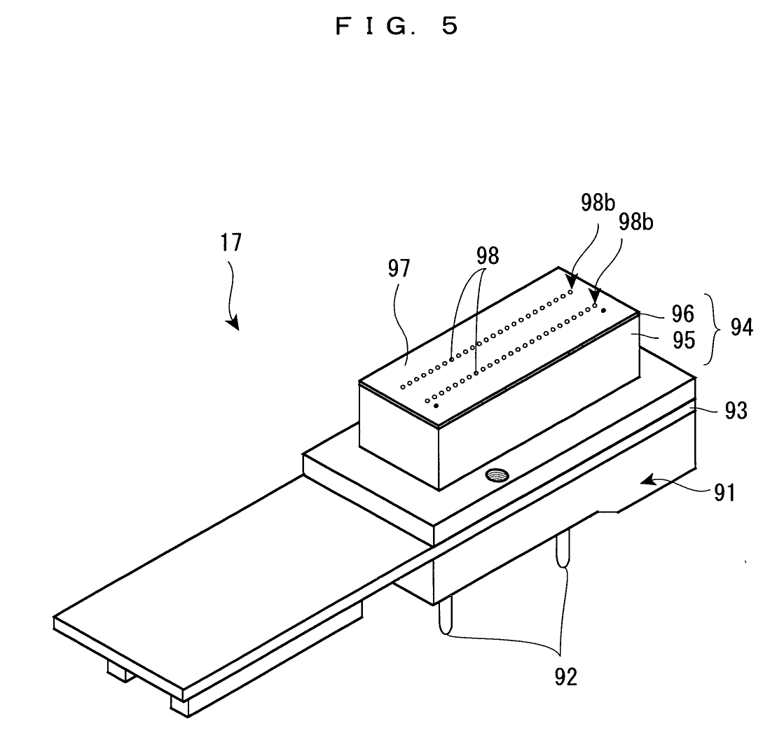

As shown in FIG. 5, each of the functional liquid droplet ejection heads 17 is a so-called twin-type head, and includes a functional liquid introduction unit 91 having twin connecting needles 92, twin head boards 93 continuing from the functional liquid introduction unit 91, and a head body 94 continuing downward from the functional liquid introduction unit 91 and being formed with an in-head flow path filled with the functional liquid therein. The connecting needles 92 are connected to the functional liquid supplying unit 7 and supply the functional liquid to the functional liquid introduction unit 91. The head body 94 includes a cavity 95 (piezoelectric element), and a nozzle plate 96 having a nozzle surface 97 provided with a number of ejection nozzles 98 opening therethrough. When the functional liquid droplet ejection heads 17 are driven for ejection, a voltage is applied to the piezoelectric element and functional liquid droplets are ejected from the ejection nozzles 98 by a pumping action of the cavities 95.

The number of ejection nozzles 98 formed on the nozzle surface 97 are divided into two split nozzle rows 98b which are arranged in parallel to each other. The two split nozzle rows 98b are arranged so as to be displaced by a half pitch from each other.

The temperature and humidity in the chamber 6 are kept constant. That is, the liquid droplet ejection apparatus 1 performs the plotting process on the workpiece W under an atmosphere of fixed temperature and humidity. A tank cabinet 84 which accommodates a tank unit 122 (which will be described hereinafter) is disposed on a portion of one of side walls of the chamber 6. Note that, when an organic EL device, for example, is manufactured, the chamber 6 is preferably filled with inert gas (nitrogen gas) as an atmosphere.

Referring now to FIG. 1 and FIGS. 6 to 9, the functional liquid supplying unit 7 will be described. The functional liquid supplying unit 7 includes the three functional liquid supplying apparatuses 101 for three colors, that is, R, G, and B. The functional liquid supplying unit 7 further includes nitrogen gas supplying units 85 which supply compression nitrogen gas to control the main tank 181 and the sub-tanks 121, for example, compression air supplying units 86 which supply compression air used to control various valves, gas exhaust units 87 which are used to exhaust gas from various units, atmosphere releasing units 88 provided so that the sub-tanks 121 are opened to the atmosphere, and a vacuuming unit 89 connected to a bubble removing unit 135. The three functional liquid supplying apparatuses 101 are connected to the functional liquid droplet ejection heads 17 corresponding to the three colors R, G, and B, and supply functional liquid of corresponding colors to the functional liquid droplet ejection heads 17.

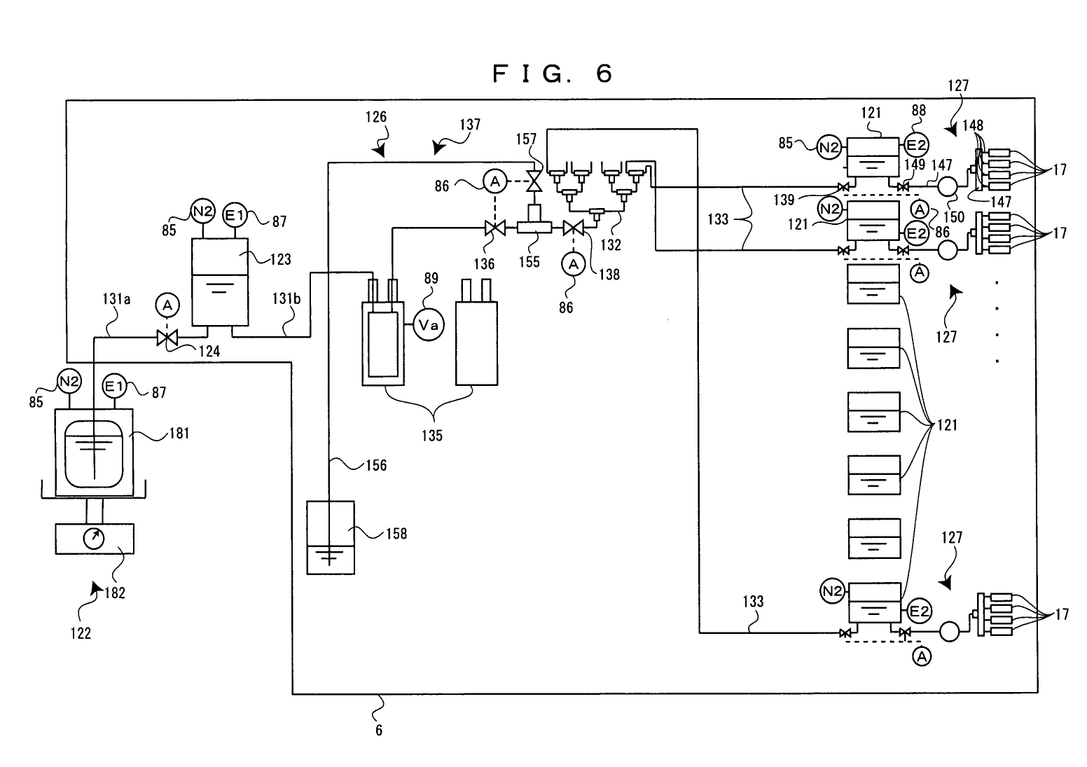

As shown in FIG. 6, each of the functional liquid supplying apparatuses 101 includes the tank unit 122 including the main tank 181 which is a supply source of functional liquid, the eight sub-tanks 121 corresponding to the carriage units 51, a buffer tank 123 arranged between the tank unit 122 and the sub-tanks 121, a functional liquid upstream channel (functional liquid channel) 126 which is used to connect the tank unit 122, the buffer tank 123, and the eight sub-tanks 121 to one another, and the functional liquid downstream channels (head-side channel) 127 which are used to connect the sub-tanks 121 to the functional liquid droplet ejection heads 17.

The functional liquid included in the main tank 181 is compressed by compression nitrogen gas supplied from one of the nitrogen gas supplying units 85 which is connected to the main tank 181 and is supplied to the buffer tank 123 and the functional liquid upstream channel 126 and selectively supplied to the eight sub-tanks 121. When the functional liquid is supplied from the main tank 181, the various valves are controlled to be opened or closed using compression air supplied from the compression air supplying units 86. Simultaneously, the selected sub-tanks 121 are opened to the atmosphere (specifically, a negative pressure control is performed on the sub-tanks 121) using the atmosphere releasing units 88. Accordingly, a required amount of functional liquid is supplied to each of the selected sub-tanks 121. The functional liquid supplied to each of the selected sub-tanks 121 is further supplied to the functional liquid droplet ejection heads 17 connected to the selected sub-tanks 121 through the functional liquid downstream channels 127 while a predetermined hydraulic head pressure is maintained by driving the functional liquid droplet ejection heads 17 connected to the selected sub-tanks 121. Although details will be described hereinafter, when the functional liquid is reversely supplied from the sub-tanks 121, the compression nitrogen gas is supplied to each of the sub-tanks 121 and the buffer tank 123 is opened to the atmosphere (specifically, a negative pressure control is performed on the buffer tank 123) through the gas exhaust units 87.

The tank unit 122 includes the main tank 181 which is a supply source of the functional liquid, as described above, and a weight measurement unit 182 which measures the weight of the main tank 181. The main tank 181 is connected to the nitrogen gas supplying units 85 and the gas exhaust units 87, and is subjected to pressure control when supplying the functional liquid by applying a pressure and is subjected to negative pressure control (that is, the main tank 181 is opened to the atmosphere) when the functional liquid is reversely supplied.

The weight measurement unit 182 is a loadcell, for example. When the functional liquid included in the main tank 181 is used and therefore the weight of the main tank 181 is reduced to a predetermined weight, the weight measurement unit 182 notifies a user of necessity of change of the main tank 181. Note that instead of the weight measurement unit 182, a liquid-level sensor or a bubble detector may be provided to issue an alert.

The functional liquid upstream channel 126 includes an upstream main channel 131a, a downstream main channel 131b, an eight-branched channel (branched channel) 132, and eight branch channels 133. The upstream main channel 131a is connected to the tank unit 122 (main tank 181) on one side thereof and connected to the buffer tank 123 on the other side thereof in the upstream side of each of the functional liquid supplying apparatuses 101. The downstream main channel 131b is connected to the buffer tank 123 on the upstream side thereof. The eight-branched channel 132 is connected to the downstream main channel 131b on the upstream side thereof. The eight branch channels 133 are connected to the eight-branched channel 132 on the upstream side thereof and connected to the sub-tanks 121 on the downstream side thereof. The functional liquid is supplied from the main tank 181, passes through the buffer tank 123, is divided into eight streams so as to pass through the eight-branched channel 132, and is supplied to the sub-tanks 121.

In the upstream main channel 131a, a first valve 124 is arranged in the vicinity of the buffer tank 123. In the downstream main channel 131b, the bubble removing unit 135, a second valve 136, an air releasing unit 137, and a third valve 138 are arranged in this order from the upstream side thereof. In the eight-branched channel 132, fourth valves 139 are arranged in the vicinity of the corresponding sub-tanks 121. When the main tank 181 is changed to a new one, the first valve 124 is closed.

In each of the functional liquid downstream channels 127, a head-side main channel 146 connected to a corresponding one of the sub-tanks 121, a four-branched channel 147 connected to the head-side main channel 146 on the upstream side thereof, a plurality of branch channels 148 connected to the four-branched channel 147 on the upstream side thereof are arranged from the upstream side of the functional liquid downstream channels 127. With this configuration, functional liquid is supplied to four channels from each of the sub-tanks 121 and further supplied to the functional liquid droplet ejection heads 17. Specifically, since the functional liquid is divided into the eight streams in the functional liquid upstream channel 126 and each of the eight streams is further divided into four streams in the functional liquid downstream channels 127, the functional liquid is supplied to 8×4 functional liquid droplet ejection heads 17. In addition, since the functional liquid supplying unit 7 has the three functional liquid supplying apparatuses 101 corresponding to R, G, and B, the functional liquid is supplied to 8×12 functional liquid droplet ejection heads 17. Note that, in the head-side main channel 146, a fifth valve 149 and a pressure reducing valve 150 are arranged.

The vacuuming unit 89 is connected to the bubble removing unit 135. The bubble removing unit 135 brings an inner channel separated using a gas permission film into a vacuum state and allows bubbles included in the functional liquid in the inner channel to transmit through the gas permission film whereby the bubbles are removed. The bubble removing unit 135 thus suppresses the generation of comparatively large bubbles such as microbubbles in the functional liquid. Accordingly, the functional liquid including the bubbles is prevented from being supplied to the sub-tanks 121, and a liquid level sensor 177, which will be described hereinafter, is prevented from performing error detection of a liquid level. Since the detection of the liquid level is precisely performed, liquid levels of the functional liquid droplet ejection heads 17 are properly maintained, and therefore, ejection defects of the functional liquid droplet ejection heads 17 are suppressed. Note that since the bubble removing unit 135 is an expendable component, a spare bubble removing unit 135 is preferably provided as shown in FIG. 6 so that the bubble removing unit 135 is immediately changed to the spare bubble removing unit 135.

The air releasing unit 137 includes an air releasing joint 155 disposed in the downstream main channel 131b, an air releasing valve 157 having a valve and a bubble sensor, an air releasing channel 156 connected to the air releasing valve 157, and a liquid storage tank 158 disposed at the downstream end of the air releasing channel 156. The air releasing unit 137 is used to initially fill the functional liquid into the functional liquid supplying apparatuses 101. When the functional liquid is supplied from the main tank 181, the air releasing valve 157 is opened and the third valve 138 is closed so that the air included in the upstream main channel 131a and the downstream main channel 131b is discharged. Then, when the air releasing valve 157 detects bubbles (after a while), the air releasing valve 157 is closed and the third valve 138 is opened. Air releasing processing is thus terminated.

The air releasing unit 137 enables appropriate release of unnecessary air when the functional liquid is initially filled into each of the functional liquid supplying apparatuses 101. That is, unnecessary air is readily eliminated when the functional liquid is initially filled into the functional liquid supplying apparatuses 101. Note that in a case where functional liquid supplied to the liquid storage tank is reused, three liquid storage tanks 158 should be provided for individual colors, whereas in a case where the functional liquid supplied to the liquid storage tank is not reused, a single liquid storage tank 158 should be provided.

The fourth valves 139 arranged upstream of the sub-tanks 121 and the fifth valves 149 arranged downstream of the sub-tanks 121 are air-operated valves which are openable and closable without volumetric changes, and suppress pulsation of the functional liquid generated when the valves are opened or closed. Therefore, the fourth valves 139 and the fifth valves 149 prevent the pulsation from being transmitted to the functional droplet ejection heads 17, and the ejection defects of the functional liquid droplet ejection heads 17 are prevented. Furthermore, since the air-operated valves are employed, there is no risk of explosion and the temperature of the functional liquid flowing through the valves is prevented from rising. Note that these valves are preferably air-operated diaphragm valves. Use of the air-operated diaphragm valves enables the valves to be opened and closed slowly, and therefore, the valves are readily opened and closed without volumetric changes.

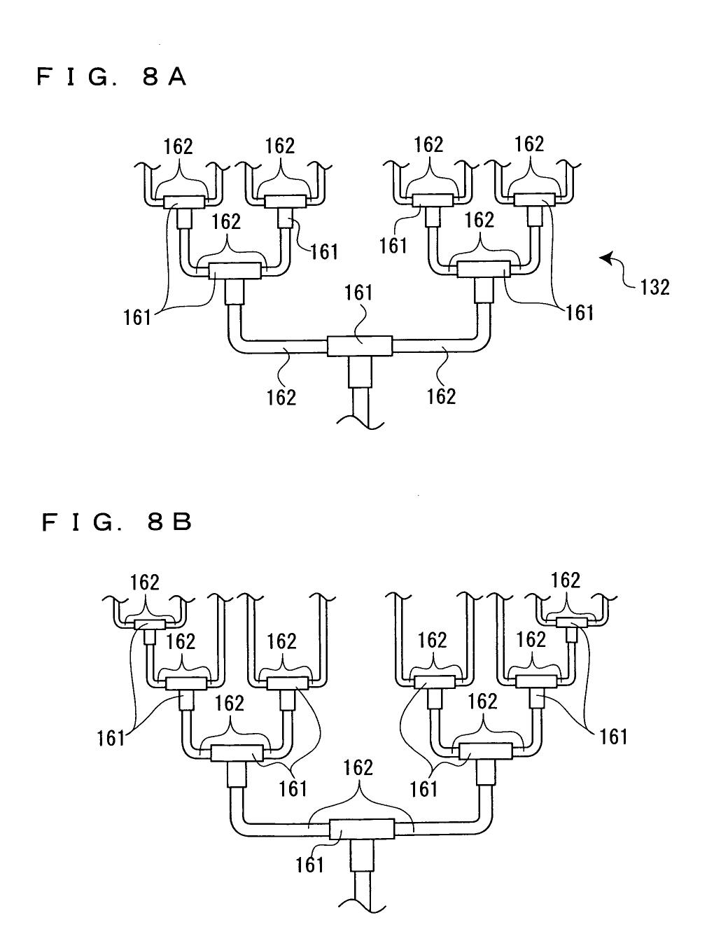

The eight-branched channel 132 includes two-branched joints 161 which are T-shaped joints and pairs of connection short tubes 162 coupled to the two-branched joints 161 at the downstream ends of the two-branched joints 161. That is, the eight-branched channel 132 is divided into two in a first stage, four in a second stage, and eight in a third stage (refer to FIG. 8A). The eight-branched channel 132 is arranged so that the upstream end thereof is positioned in a lower side and the downstream end thereof is positioned in an upper side. Accordingly, the functional liquid supplied from the tank unit 122 flows upward in the eight-branched channel 132. Use of the eight-branched channel 132 makes pressure losses of the pairs of connection short tubes 162 disposed on the most downstream side identical, and therefore, makes flow rates of the eight branch channels 133 fixed. Furthermore, since the upstream end of the eight-branched channel 132 is positioned in the lower side and the downstream end of the eight-branched channel 132 is positioned in the upper side and therefore the functional liquid flows from the lower side to the upper side, air is prevented from remaining in the eight-branched channel 132. In addition, an inexpensive eight-branched channel 132 is obtained by employing inexpensive T-shaped joints for the two-branched joints 161.

In the eight-branched channel 132, diameters of the two-branched joints 161 and the pairs of two-branched joints 161 in the first stage are larger than those of the two-branched joints 161 and the pairs of two-branched joints 161 in the third stage. Consequently, a pressure loss of the eight-branched channel 132 is reduced as much as possible.

Note that the eight-branched channel 132 employed in this embodiment is appropriately obtained by dividing the channel in the three stages to obtain eight ends. However, for example, a ten-branched channel is to be employed, as shown in FIG. 8B, the ten-branched channel is configured such that functional liquid flows through three two-branched joints 161 and three pairs of connection short tubes 162 and is output from six ends of the ten-branched channel, and the functional liquid flows through four two-branched joints 161 and four pairs of connection short tubes 162 and is output from four ends of the ten-branched channel. In this case, since lengths of channels connected to the six ends are different from lengths of channels connected to the four ends, flow rates of the functional liquid flowing from the six ends to the corresponding sub-tanks 121 are different from flow rates of the functional liquid flowing from the four ends to the corresponding sub-tanks 121. To address this problem, the pressure losses are controlled by adjusting lengths of the pairs of connection short tubes 162 for the four ends in a fourth stage and lengths of the pairs of connection short tubes 162 for the six ends in a third stage.

The four-branched channels 147 of the functional liquid downstream channels 127 preferably have configurations similar to the configuration of the eight-branched channel 132. Note that, in this case, upstream ends of the four-branched channels 147 are preferably positioned in upper sides thereof and downstream ends of the four-branched channels 147 are preferably positioned in lower sides thereof. With this configuration, even when bubbles are mixed in the functional liquid flowing in the functional liquid downstream channels 127, the bubbles are transmitted to the sub-tanks 121.

Pressure reducing valves 150 operate in accordance with an atmospheric pressure, and are used to maintain hydraulic head values between the pressure reducing valve 150 and the corresponding functional liquid droplet ejection heads 17 within a predetermined allowable range. Use of the pressure reducing valve 150 enables hydraulic head values of the functional liquid at nozzle surfaces 97 of the functional liquid droplet ejection heads 17 to be accurately maintained.

The buffer tank 123 is disposed in the chamber 6 and is disposed in the vicinity of the tank unit 122. The functional liquid supplied from the main tank 181 is supplied through the buffer tank 123 to the sub-tanks 121. The buffer tank 123 is used as a substitute of the main tank 181 and supplies functional liquid to the sub-tanks 121 when the main tank 181 is changed to a new one. Operation of the buffer tank 123 will be described hereinafter. The buffer tank 123 is connected to one of the nitrogen gas supplying units 85 and one of the gas exhaust units 87, and performs pressure control when supplying the functional liquid by applying a pressure and performs negative pressure control (that is, the buffer tank 123 is opened to the atmosphere) when the supply of the functional liquid by applying a pressure is cancelled. Although described in detail hereinafter, the pressure control is performed only when the main tank 181 is changed to a new one, and the negative pressure control is performed only when the functional liquid is reversely supplied, and otherwise, the buffer tank 123 normally functions as a sealed tank.

Note that in this embodiment, the functional liquid is supplied from the main tank 181 through the buffer tank 123 to the sub-tanks 121. However, the buffer tank 123 may be connected to a channel branching from the functional liquid upstream channel 126. In this case, a channel other than the functional liquid upstream channel 126 should be provided for supplying the functional liquid to the buffer tank 123.

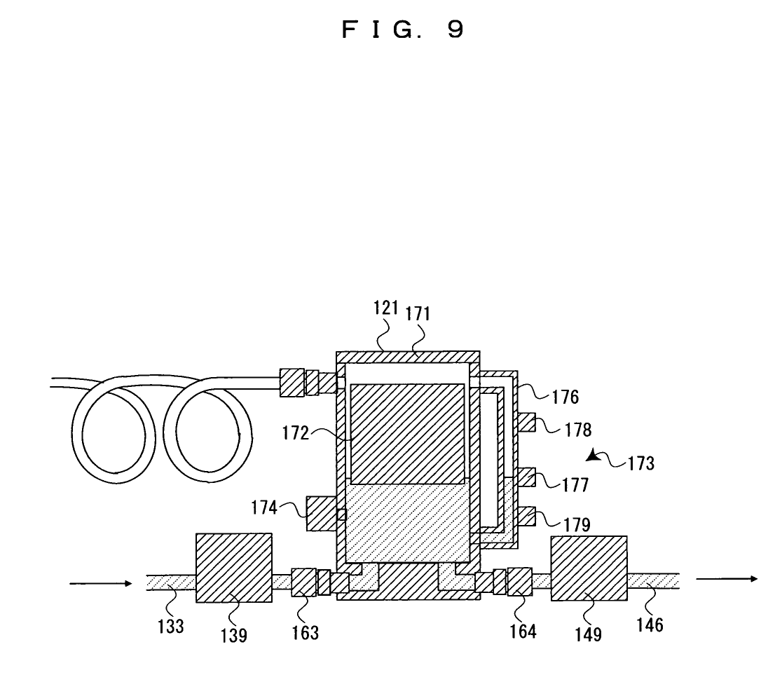

As shown in FIG. 9, each of the sub-tanks 121 includes a sub-tank body 171, a lid body float 172, a bypass tube 176, a liquid level detection unit 173, and a liquid pressure sensor 174. The sub-tank body 171 stores functional liquid, the lid body float 172 is placed inside each of the sub-tanks 121, the bypass tube 176 is disposed on one of the sides of the sub-tank body 171, the liquid level detection unit 173 detects a level of the stored functional liquid, and the liquid pressure sensor 174 is disposed on a lower portion of another one of the sides of the sub-tank body 171. In each of the sub-tanks 121, a corresponding one of the nitrogen gas supplying units 85 and a corresponding one of the atmosphere releasing units 88 are connected to the upper side of the sub-tank body 171 (as shown in FIG. 6) so that a negative pressure control is performed when the functional liquid is supplied from the main tank 181 and a pressure control is performed when the functional liquid is supplied to the main tank 181. Furthermore, a first inflow joint 163 connected to a corresponding one of the eight branch channels 133 and a second inflow joint 164 connected to the head-side main channel 146 are disposed on the lower side of the sub-tank body 171. The functional liquid is input from the lower side of the sub-tank body 171 and is output from the lower side of the sub-tank body 171.

The liquid level detection unit 173 faces the bypass tube 176 and includes an upper limit sensor 178 which detects an upper limit level of the functional liquid, a lower limit sensor 179 which detects a lower limit level of the functional liquid, and a liquid level sensor 177 which is disposed between the upper limit sensor 178 and the lower limit sensor 179 and which detects a level of the supplied functional liquid. The upper limit sensor 178 prevents a corresponding one of the sub-tanks 121 from being overflowing. When the upper limit sensor 178 detects the upper limit level of the functional liquid, the main tank 181 stops supplying the functional liquid. The lower limit sensor 179 prevents the corresponding one of the sub-tanks 121 from being empty. When the lower limit sensor 179 detects the lower limit level of the functional liquid, the liquid droplet ejection apparatus 1 stops operating when plotting of a current workpiece W is terminated.

After the upper limit sensor 178 detects the upper limit level of the functional liquid, a reverse supply operation in which the functional liquid supplied in the sub-tanks 121 is reversely supplied to the buffer tank 123 is performed. In this reverse supply operation, for each of the sub-tanks 121, when the fifth valve 149 is closed, the fourth valve 139 is simultaneously opened and the first valve 124 is closed, and thereafter, a pressure is applied in a corresponding one of the sub-tanks 121 (pressure control) so that the functional liquid is reversely supplied. Then, the liquid level sensor 177 detects the liquid level, and the reverse supply operation is terminated. By appropriately performing the reverse supply operation, the functional liquid is prevented from being oversupplied to the sub-tanks 121 and being discarded. Note that although the functional liquid is reversely supplied to the buffer tank 123 in the reverse supply operation in this embodiment, the functional liquid may be supplied through the buffer tank 123 to the main tank 181. In this case, the first valve 124 is opened and the pressure control performed on the main tank 181 is cancelled.

The liquid level sensor 177 detects a liquid level taking ideal hydraulic head values of the corresponding functional liquid droplet ejection heads 17 into consideration. When the liquid level sensor 177 detects a liquid level of the functional liquid, the liquid level sensor 177 cooperates with a controller, which will be described hereinafter, and determines that the corresponding one of the sub-tanks 121 is full or a level of the functional liquid in the corresponding one of the sub-tanks 121 is low. Specifically, when the functional liquid is reduced from a liquid level over the liquid level sensor 177 to a liquid level corresponding to a level of the liquid level sensor 177 due to a functional liquid ejection operation, the level of the functional liquid is determined to be low. On the other hand, when the functional liquid is increased from a liquid level under the liquid level sensor 177 to a liquid level corresponding to the level of the liquid level sensor 177 due to a functional liquid supply operation and then a predetermined period passes in this state, the corresponding one of the sub-tanks 121 is determined to be full. The liquid level sensor 177 is thus used to control the liquid level of the functional liquid in a corresponding one of the sub-tanks 121 to stay within a range around an intermediate portion of the corresponding one of the sub-tanks 121. Since the liquid level of the functional liquid is controlled to stay within a range around the intermediate portion of each of the sub-tanks 121, a large space (gas capacity) which is not filled with the functional liquid is normally maintained in each of the sub-tanks 121. With this configuration, pulsations of the functional liquid generated upstream of the sub-tanks 121 are absorbed, and ejection defects of the functional liquid droplet ejection heads 17 are suppressed.

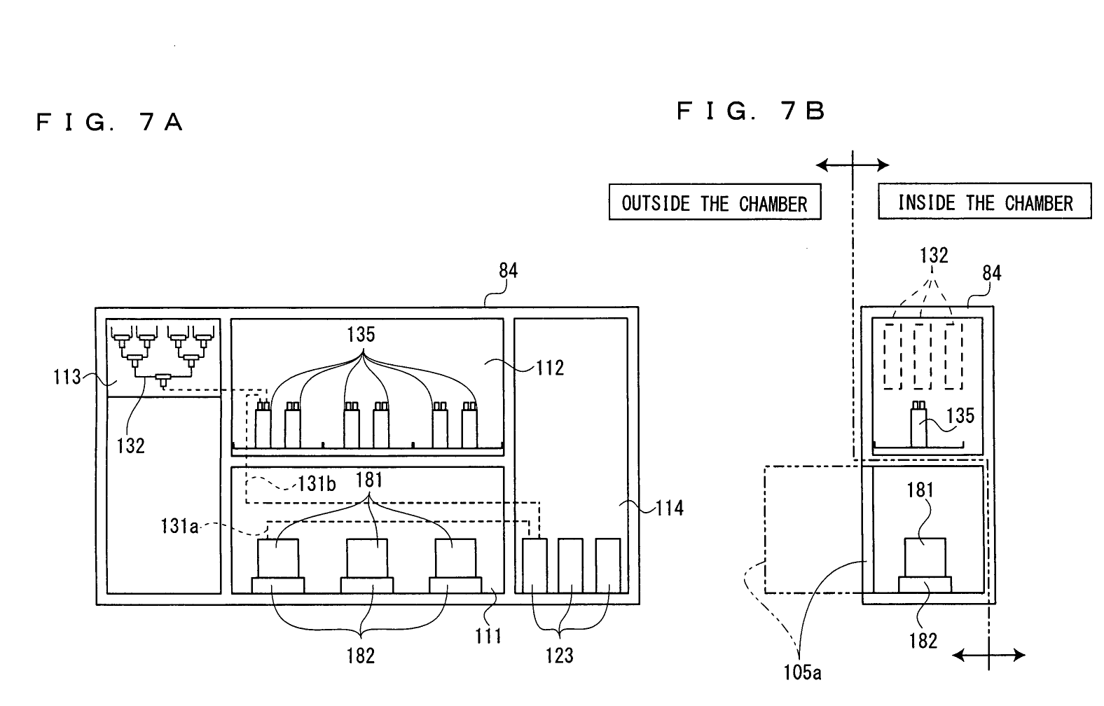

As shown in FIG. 7, in each of the functional liquid supplying apparatuses 101, the components from the tank unit 122 to the eight-branched channel 132 from the downstream side are stored in the tank cabinet 84 disposed on one of the sides of the chamber 6 (refer to FIG. 1). As shown in FIG. 7, the tank cabinet 84 includes a main tank accommodation section 111 which accommodates tank units 122, a buffer tank accommodation section 114 which accommodates buffer tanks 123 and which is disposed adjacent to the main tank accommodation section 111 (on the right side of the main tank accommodation section 111 in FIG. 7), a unit accommodation section 112 which accommodates the bubble removing units 135 and which is disposed on the main tank accommodation section 111, and a branched channel accommodation section 113 which accommodates eight-branched channels 132 and which is disposed adjacent to the unit accommodation section 112 (on the left side of the unit accommodation section 112 in FIG. 7).

The main tank accommodation section 111 has a door 105a which is opened toward the outside of the chamber 6. Although not shown, the buffer tank accommodation section 114, the unit accommodation section 112, and the branched channel accommodation section 113 have respective doors which are opened toward the inside of the chamber 6. Specifically, eight-branched channels 132, bubble removing units 135, and eight-branched channels 132 are arranged in the chamber 6, and tank units 122 are arranged outside the chamber 6. Accordingly, main tanks 181 included in the tank units 122 can be replaced without substituting the atmosphere in the chamber 6 with atmospheric air. As described above, since the tank units 122 are arranged outside the chamber 6, the chamber 6 is not required to be opened when each of the main tanks 181 is changed to a new one. Accordingly, the atmosphere in the chamber 6 is not disturbed every time each of the main tanks 181 is replaced. That is, since each of the main tanks 181 is replaced with a new one without re-controlling the temperature and humidity in the chamber 6 (in a case where the chamber 6 is filled with inert gas, the inert gas is not leaked to the outside), the productivity of the apparatus is improved.

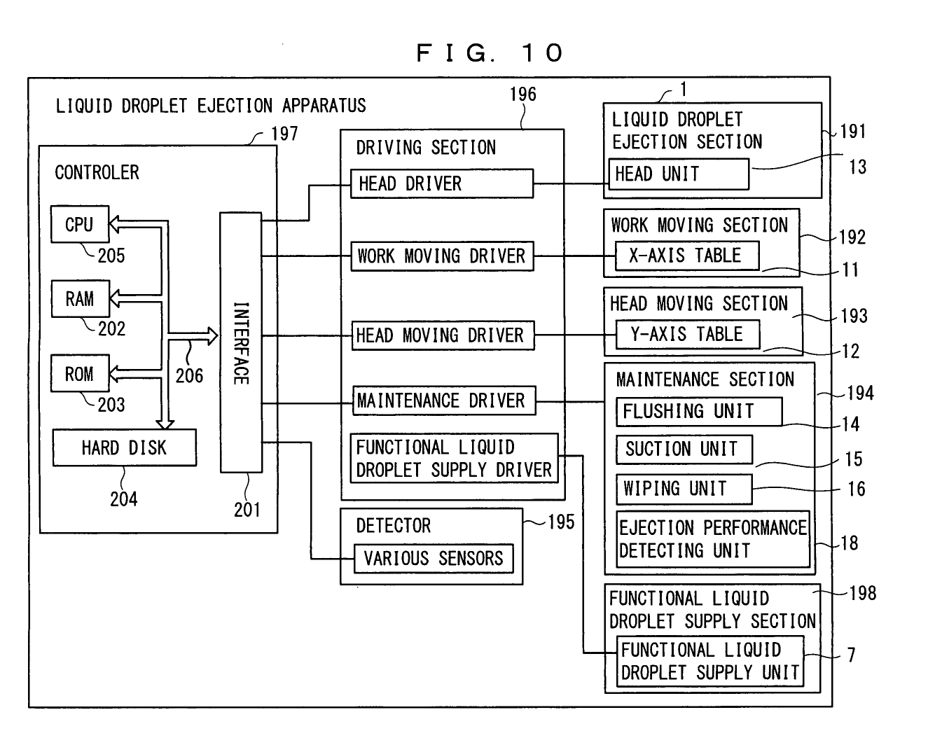

Referring to FIG. 10, a main control system of the liquid droplet ejection apparatus 1 will be described. As shown in FIG. 10, the liquid droplet ejection apparatus 1 includes a liquid droplet ejection section 191, a workpiece moving section 192, a head moving section 193, a maintenance section 194, a function liquid supply section 198, a detector 195, a driving section 196, and a controller 197 (the liquid feeding control device and the liquid level control device). The liquid droplet ejection section 191 includes the head unit 13 (the functional liquid droplet ejection heads 17). The workpiece moving section 192 includes the X-axis table 11 and is used to move the workpiece W in the X-axis direction. The head moving section 193 includes the Y-axis table 12 and is used to move the head unit 13 in the Y-axis direction. The maintenance section 194 includes units used for maintenance. The functional liquid supply section 198 includes the functional liquid supply unit 7 and supplies the functional liquid to the functional liquid droplet ejection heads 17. The detector 195 includes various sensors used for various detection operations. The driving unit 196 includes various drivers which control and drive these individual sections. The controller 197 is connected to the individual sections and entirely controls the liquid droplet ejection apparatus 1.

The controller 197 includes various components such as an interface 201, a RAM 202, a ROM 203, a hard disk 204, a CPU 205, and a bus 206. The interface 201 is used to connect the various units to each other. The RAM 202 has a storage area capable of storing data temporarily and is used as a workspace for control processing. The ROM 203 has various storage areas and is used to store control programs and control data. The hard disk 204 stores plotted data used when a predetermined plotting pattern is plotted onto the workpiece W and a variety of data transmitted from the various units, and further stores programs used for processing the variety of data. The CPU 205 performs calculation processing for the variety of data in accordance with the programs stored in the ROM 203 and the hard disk 204. The bus 206 is used to connect the components to each other.

The controller 197 is used to input the variety of data transmitted from the various units through the interface 201 and allows the CPU 205 to perform the calculation processing in accordance with the programs stored in the hard disk 204 (or in accordance with the programs read from the ROM 203 using a CD-ROM drive, for example). A result of the calculation processing is output to the units through the driving section 196 (the various drivers). Thus, the liquid droplet ejection apparatus 1 is entirely controlled and various processes of the liquid droplet ejection apparatus 1 are performed.

A functional liquid supply operation to the functional liquid droplet ejection heads 17 will be explained. In this operation, the functional liquid is stored in each of the main tanks 181, the buffer tank 123 and each of the sub tanks 121, and the operation is performed in a state that the functional liquid is filled in each of the channels. Additionally, one of the main tanks 181 is pressurized by the nitrogen gas supply unit 85.

With a state in which the fourth valve 139 provided on the upstream side of the sub tank 121 is closed, the functional liquid droplet ejection heads 17 are driven to eject the functional liquid droplets. As the fourth valve 139 is closed, the pressure from the main tank 181 is freed and the functional liquid is fed from each of the sub tanks 121 to each of the functional liquid droplet ejection heads 17 with a pumping action of the functional liquid droplet ejection heads 17. Note that the hydraulic head value at the nozzle surface 97 of the functional liquid droplet ejection head 17 is in a final adjustment by the pressure reducing valve 150 provided on the downstream side functional liquid channel 127. Also, the control for the hydraulic head value is assisted with the negative control within the sub tanks 121 by the atmosphere releasing units 88. Thus, a management for the hydraulic head value by the pressure reducing valve 150 is assisted with the negative control of the sub tanks 121, leading to a large amount of difference between the full level and the decreasing level in the sub tanks 121. Therefore, the sub tanks 121 can be configured with smaller volumes.

A replenishment of the functional liquid to the sub tanks 121 will be explained. When a certain amount of the functional liquid in the sub tanks 121 decreases by the ejecting process of the functional liquid droplet ejection heads 17, a decreased liquid state is detected by the liquid level detection mechanism 173. In a case where the decreased liquid state is detected, the functional liquid is replenished from the main tank 181 to the sub tanks 121 through the opening of the fourth valve 139. As the main tank 181 is pressurized, the functional liquid in the main tank 181 is fed to the sub tanks 121 automatically by opening the fourth valve 139. Note that, in this case, the ejecting process of the functional liquid droplet ejection heads 17 continues.

When the functional liquid is fed from the main tank 181 to the sub tanks 121, and is stored in the sub tanks 121 with a certain amount, the full liquid state in the sub tanks 121 is detected by the liquid level detection mechanism 173. As the full liquid state is detected, the fourth valve 139 is closed to complete the replenishment operation. Note that the above reverse feeding process of the functional liquid is performed by the above control system.

A handling operation at the time of no functional liquid in the main tank 181 will be explained. As the replenishment operation to the sub tanks 121 is repeated, the functional liquid in the main tank 181 decreases, and it is detected by the weight measuring apparatus 182 that the main tank 181 needs to be changed. When it is determined that the main tank 181 needs to be changed, the first valve 124 is closed, the buffer tank 123 is pressurized, and then, the replenishment operation to the sub tanks 121 is performed by the buffer tank 123. At this time, the main tank 181 which needs to be changed is changed. Therefore, without stopping the supply operation to the sub tanks 121 (ejecting drive of the functional liquid droplet ejection heads 17), the main tanks 181 can be changed. Thus, by having buffer tanks 123, it is possible to replenish the functional liquid to each of the sub tanks 121 when the main tanks 181 are changed. Therefore, it is not necessary to stop the plotting process by the functional liquid droplet ejection heads 17 and the productivity can be increased.

According to the structure above, when the functional liquid of one of the main tanks 181 runs out, with the nitrogen gas supplying units 85 and the fourth valve 139, it is possible to supply the functional liquid to each of the sub tanks 121 from the buffer tank 123. Therefore, when one of the main tank 181 is changed to the other of the main tank 181, it is possible to continue to replenish to each of the sub tanks 121, leading to a high productivity without stopping the plotting process by the functional liquid droplet ejection heads 17.

In this embodiment, the liquid droplet ejection apparatus 1 having eight carriage units 51 is used, but the number of the carriage units 51 is discretionary.

Taking electro-optical apparatuses (flat panel display apparatuses) manufactured using the liquid droplet ejection apparatus 1 and active matrix substrates formed on the electro-optical apparatuses as display apparatuses as examples, configurations and manufacturing methods thereof will now be described. Examples of the electro-optical apparatuses include a color filter, a liquid crystal display apparatus, an organic EL apparatus, a plasma display apparatus (PDP (plasma display panel) apparatus), and an electron emission apparatus (FED (field emission display) apparatus and SED (surface-conduction electron emitter display) apparatus). Note that the active matrix substrate includes thin-film transistors, source lines and data lines which are electrically connected to the thin film transistors.

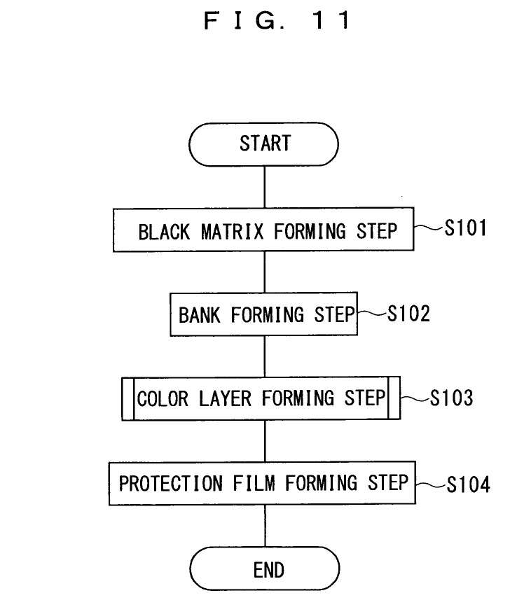

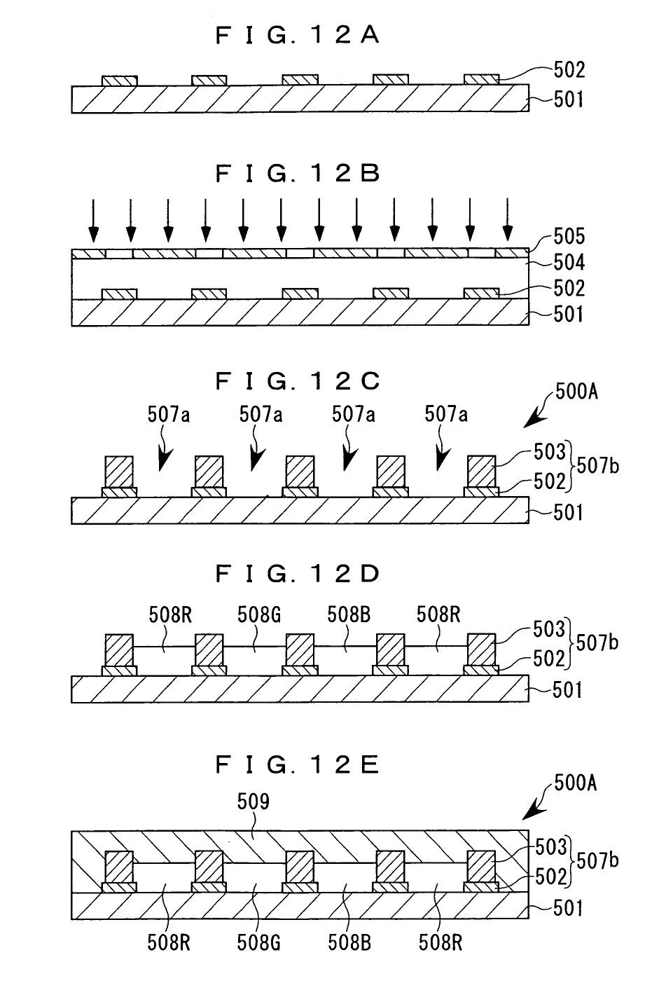

First, a manufacturing method of a color filter incorporated in a liquid crystal display apparatus or an organic EL apparatus will be described. FIG. 11 shows a flowchart illustrating manufacturing steps of a color filter. FIGS. 12A to 12E are sectional views of the color filter 500 (a filter substrate 500A) of this embodiment shown in an order of the manufacturing steps.

In a black matrix forming step (step S101), as shown in FIG. 12A, a black matrix 502 is formed on the substrate (W) 501. The black matrix 502 is formed of a chromium metal, a laminated body of a chromium metal and a chromium oxide, or a resin black, for example. The black matrix 502 may be formed of a thin metal film by a sputtering method or a vapor deposition method. Alternatively, the black matrix 502 may be formed of a thin resin film by a gravure plotting method, a photoresist method, or a thermal transfer method.

In a bank forming step (step S102), the bank 503 is formed so as to be superposed on the black matrix 502. Specifically, as shown in FIG. 12B, a resist layer 504 which is formed of a transparent negative photosensitive resin is formed so as to cover the substrate 501 and the black matrix 502. An upper surface of the resist layer 504 is covered with a mask film 505 formed in a matrix pattern. In this state, exposure processing is performed.

Furthermore, as shown in FIG. 12C, the resist layer 504 is patterned by performing etching processing on portions of the resist layer 504 which are not exposed, and the bank 503 is thus formed. Note that when the black matrix 502 is formed of a resin black, the black matrix 502 also serves as a bank.

The bank 503 and the black matrix 502 disposed beneath the bank 503 serve as a partition wall 507b for partitioning the pixel areas 507a. The partition wall 507b defines receiving areas for receiving the functional liquid ejected when the functional liquid droplet ejection heads 17 form coloring layers (film portions) 508R, 508G, and 508B in a subsequent coloring layer forming step.

The filter substrate 500A is obtained through the black matrix forming step and the bank forming step.

Note that, in this embodiment, a resin material having a lyophobic (hydrophobic) film surface is used as a material of the bank 503. Since a surface of the substrate (glass substrate) 501 is lyophilic (hydrophilic), variation of positions to which the liquid droplet is projected in the each of the pixel areas 507a surrounded by the bank 503 (partition wall 507b) can be automatically corrected in the subsequent coloring layer forming step.

In the coloring layer forming step (S103), as shown in FIG. 12D, the functional liquid droplet ejection heads 17 eject the functional liquid within the pixel areas 507a each of which are surrounded by the partition wall 507b. In this case, the functional liquid droplet ejection heads 17 eject functional liquid droplets using functional liquids (filter materials) of colors R, G, and B. A color scheme pattern of the three colors R, G, and B may be the stripe arrangement, the mosaic arrangement, or the delta arrangement.

Then drying processing (such as heat treatment) is performed so that the three color functional liquids are fixed, and thus three coloring layers 508R, 508G, and 508B are formed. Thereafter, a protective film forming step is reached (step S104). As shown in FIG. 12E, a protective film 509 is formed so as to cover surfaces of the substrate 501, the partition wall 507b, and the three coloring layers 508R, 508G, and 508B.

That is, after liquid used for the protective film is ejected onto the entire surface of the substrate 501 on which the coloring layers 508R, 508G, and 508B are formed and the drying process is performed, the protective film 509 is formed.

In the manufacturing method of the color filter 500, after the protective film 509 is formed, a coating step is performed in which ITO (Indium Tin Oxide) serving as a transparent electrode in the subsequent step is coated.

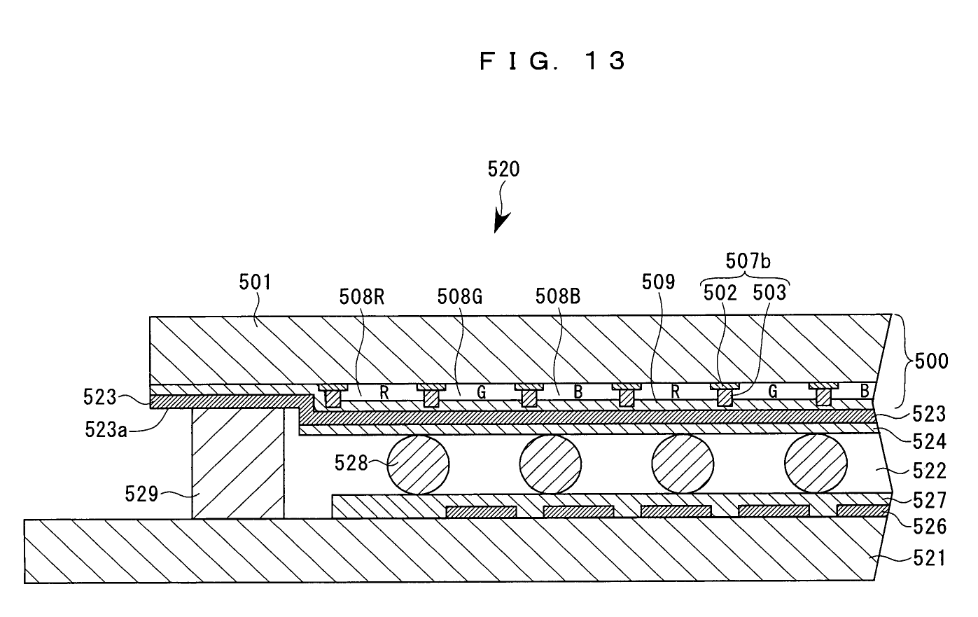

FIG. 13 is a sectional view of an essential part of a passive matrix liquid crystal display apparatus (liquid crystal display apparatus 520) and schematically illustrates a configuration thereof as an example of a liquid crystal display apparatus employing the color filter 500. A transmissive liquid crystal display apparatus as a final product can be obtained by disposing a liquid crystal driving IC (integrated circuit), a backlight, and additional components such as supporting members on the display apparatus 520. Note that the color filter 500 is the same as that shown in FIGS. 12A to 12E, and therefore, reference numerals the same as those used in FIGS. 12A to 12E to denote the same components, and descriptions thereof are omitted.

The display apparatus 520 includes the color filter 500, a counter substrate 521 such as a glass substrate, and a liquid crystal layer 522 formed of STN (super twisted nematic) liquid crystal compositions sandwiched therebetween. The color filter 500 is disposed on the upper side of FIG. 13 (on an observer side).

Although not shown, polarizing plates are disposed so as to face an outer surface of the counter substrate 521 and an outer surface of the color filter 500 (surfaces which are remote from the liquid crystal layer 522). A backlight is disposed so as to face an outer surface of the polarizing plate disposed near the counter substrate 521.

A plurality of rectangular first electrodes 523 extending in a horizontal direction in FIG. 13 are formed with predetermined intervals therebetween on a surface of the protective film 509 (near the liquid crystal layer 522) of the color filter 500. A first alignment layer 524 is arranged so as to cover surfaces of the first electrodes 523 which are surfaces remote from the color filter 500.

On the other hand, a plurality of rectangular second electrodes 526 extending in a direction perpendicular to the first electrodes 523 disposed on the color filter 500 are formed with predetermined intervals therebetween on a surface of the counter substrate 521 which faces the color filter 500. A second alignment layer 527 is arranged so as to cover surfaces of the second electrodes 526 near the liquid crystal layer 522. The first electrodes 523 and the second electrodes 526 are formed of a transparent conductive material such as an ITO.

A plurality of spacers 528 disposed in the liquid crystal layer 522 are used to maintain the thickness (cell gap) of the liquid crystal layer 522 constant. A seal member 529 is used to prevent the liquid crystal compositions in the liquid crystal layer 522 from leaking to the outside. Note that an end of each of the first electrodes 523 extends beyond the seal member 529 and serves as wiring 523a.

Pixels are arranged at intersections of the first electrodes 523 and the second electrodes 526. The coloring layers 508R, 508G, and 508B are arranged on the color filter 500 so as to correspond to the pixels.

In normal manufacturing processing, the first electrodes 523 are patterned and the first alignment layer 524 is applied on the color filter 500 whereby a first half portion of the display apparatus 520 on the color filter 500 side is manufactured. Similarly, the second electrodes 526 are patterned and the second alignment layer 527 is applied on the counter substrate 521 whereby a second half portion of the display apparatus 520 on the counter substrate 521 side is manufactured. Thereafter, the spacers 528 and the seal member 529 are formed on the second half portion, and the first half portion is attached to the second half portion. Then, liquid crystal to be included in the liquid crystal layer 522 is injected from an inlet of the seal member 529, and the inlet is sealed. Finally, the polarizing plates and the backlight are disposed.

The liquid droplet ejection apparatus 1 of this embodiment may apply a spacer material (functional liquid) constituting the cell gap, for example, and uniformly apply liquid crystal (functional liquid) to an area sealed by the seal member 529 before the first half portion is attached to the second half portion. Furthermore, the seal member 529 may be printed using the functional liquid droplet ejection heads 17. Moreover, the first alignment layer 524 and the second alignment layer 527 may be applied using the functional liquid droplet ejection heads 17.

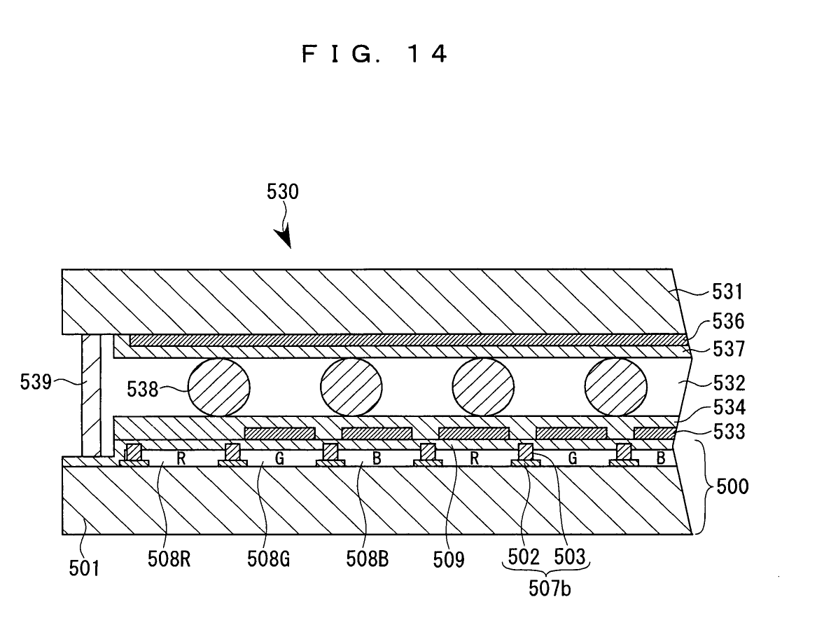

FIG. 14 is a sectional view of an essential part of a display apparatus 530 and schematically illustrates a configuration thereof as a second example of a liquid crystal display apparatus employing the color filter 500 which is manufactured in this embodiment.

The display apparatus 530 is considerably different from the display apparatus 520 in that the color filter 500 is disposed on a lower side in FIG. 14 (remote from the observer).

The display apparatus 530 is substantially configured such that a liquid crystal layer 532 constituted by STN liquid crystal is arranged between the color filter 500 and a counter substrate 531 such as a glass substrate. Although not shown, polarizing plates are disposed so as to face an outer surface of the counter substrate 531 and an outer surface of the color filter 500.

A plurality of rectangular first electrodes 533 extending in a depth direction of FIG. 14 are formed with predetermined intervals therebetween on a surface of the protective film 509 (near the liquid crystal layer 532) of the color filter 500. A first alignment layer 534 is arranged so as to cover surfaces of the first electrodes 533 which are surfaces near the liquid crystal layer 532.

On the other hand, a plurality of rectangular second electrodes 536 extending in a direction perpendicular to the first electrodes 533 disposed on the color filter 500 are formed with predetermined intervals therebetween on a surface of the counter substrate 531 which faces the color filter 500. A second alignment layer 537 is arranged so as to cover surfaces of the second electrodes 536 near the liquid crystal layer 532.

A plurality of spacers 538 disposed in the liquid crystal layer 532 are used to maintain the thickness (cell gap) of the liquid crystal layer 532 constant. A seal member 539 is used to prevent the liquid crystal compositions in the liquid crystal layer 532 from leaking to the outside.

As with the display apparatus 520, pixels are arranged at intersections of the first electrodes 533 and the second electrodes 536. The coloring layers 508R, 508G, and 508B are arranged on the color filter 500 so as to correspond to the pixels.

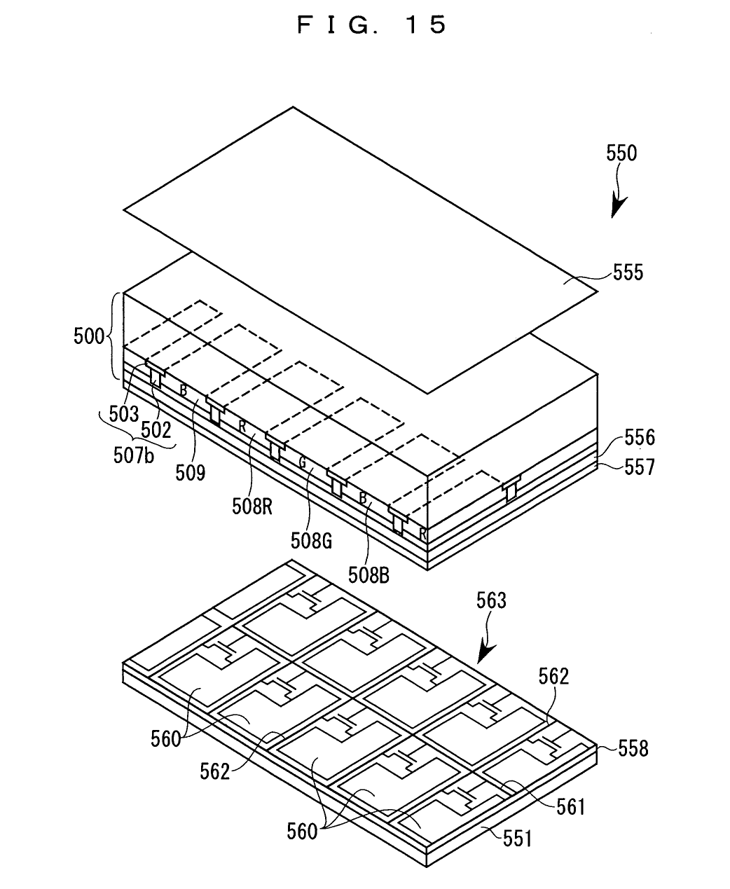

FIG. 15 is an exploded perspective view of a transmissive TFT (thin film transistor) liquid crystal display device and schematically illustrates a configuration thereof as a third example of a liquid crystal display apparatus employing the color filter 500 to which the invention is applied.

A liquid crystal display apparatus 550 has the color filter 500 disposed on the upper side of FIG. 15 (on the observer side).

The liquid crystal display apparatus 550 includes the color filter 500, a counter substrate 551 disposed so as to face the color filter 500, a liquid crystal layer (not shown) interposed therebetween, a polarizing plate 555 disposed so as to face an upper surface of the color filter 500 (on the observer side), and a polarizing plate (not shown) disposed so as to face a lower surface of the counter substrate 551.

An electrode 556 used for driving the liquid crystal is formed on a surface of the protective film 509 (a surface near the counter substrate 551) of the color filter 500. The electrode 556 is formed of a transparent conductive material such as an ITO and entirely covers an area in which pixel electrodes 560 are to be formed which will be described later. An alignment layer 557 is arranged so as to cover a surface of the electrode 556 remote from the pixel electrode 560.

An insulating film 558 is formed on a surface of the counter substrate 551 which faces the color filter 500. On the insulating film 558, scanning lines 561 and signal lines 562 are arranged so as to intersect with each other. Pixel electrodes 560 are formed in areas surrounded by the scanning lines 561 and the signal lines 562. Note that an alignment layer (not shown) is arranged on the pixel electrodes 560 in an actual liquid crystal display apparatus.

Thin-film transistors 563 each of which includes a source electrode, a drain electrode, a semiconductor layer, and a gate electrode are incorporated in areas surrounded by notch portions of the pixel electrodes 560, the scanning lines 561, and the signal lines 562. When signals are supplied to the scanning lines 561 and the signal lines 562, the thin-film transistors 563 are turned on or off so that power supply to the pixel electrodes 560 is controlled.

Note that although each of the display apparatuses 520, 530, and 550 is configured as a transmissive liquid crystal display apparatus, each of the display apparatuses 520, 530, and 550 may be configured as a reflective liquid crystal display apparatus having a reflective layer or a semi-transmissive liquid crystal display apparatus having a semi-transmissive reflective layer.

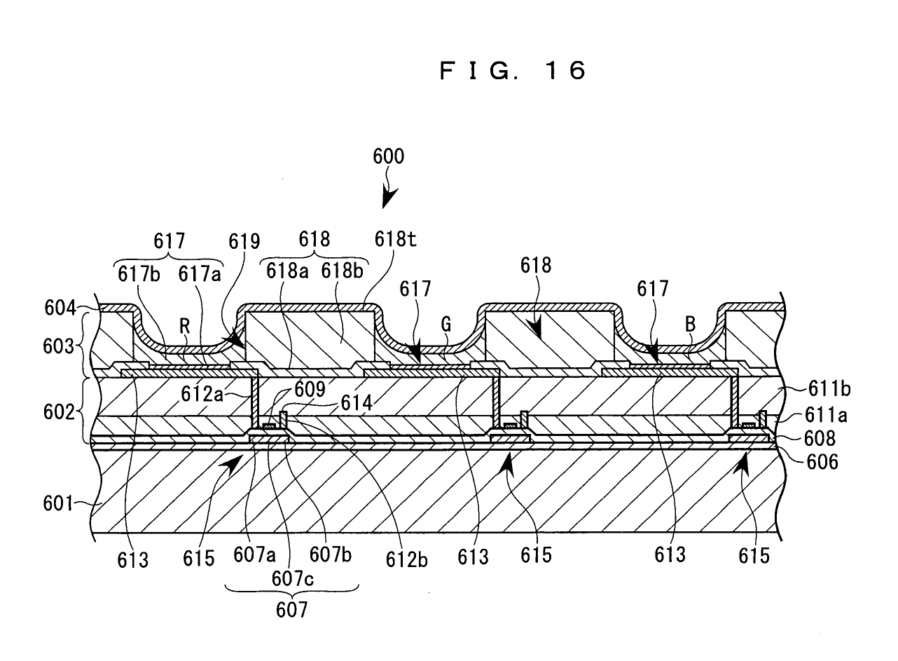

FIG. 16 is a sectional view illustrating an essential part of a display area of an organic EL apparatus (hereinafter simply referred to as a display apparatus 600).

In this display apparatus 600, a circuit element portion 602, a light-emitting element portion 603, and a cathode 604 are laminated on a substrate (W) 601.

In this display apparatus 600, light is emitted from the light-emitting element portion 603 through the circuit element portion 602 toward the substrate 601 and eventually is emitted to an observer side. In addition, light emitted from the light-emitting element portion 603 toward an opposite side of the substrate 601 is reflected by the cathode 604, and thereafter passes through the circuit element portion 602 and the substrate 601 to be emitted to the observer side.

An underlayer protective film 606 formed of a silicon oxide film is arranged between the circuit element portion 602 and the substrate 601. Semiconductor films 607 formed of polysilicon oxide films are formed on the underlayer protective film 606 (near the light-emitting element portion 603) in an isolated manner. In each of the semiconductor films 607, a source region 607a and a drain region 607b are formed on the left and right sides thereof, respectively, by high-concentration positive-ion implantation. The center portion of each of the semiconductor films 607 which is not subjected to high-concentration positive-ion implantation serves as a channel region 607c.

In the circuit element portion 602, the underlayer protective film 606 and a transparent gate insulating film 608 covering the semiconductor films 607 are formed. Gate electrodes 609 formed of, for example, Al, Mo, Ta, Ti, or W are disposed on the gate insulating film 608 so as to correspond to the channel regions 607c of the semiconductor films 607. A first transparent interlayer insulating film 611a and a second transparent interlayer insulating film 611b are formed on the gate electrodes 609 and the gate insulating film 608. Contact holes 612a and 612b are formed so as to penetrate the first interlayer insulating film 611a and the second interlayer insulating film 611b and to be connected to the source region 607a and the drain region 607b of the semiconductor films 607.

Pixel electrodes 613 which are formed of ITOs, for example, and which are patterned to have a predetermined shape are formed on the second interlayer insulating film 611b. The pixel electrode 613 is connected to the source region 607a through the contact holes 612a.

Power source lines 614 are arranged on the first interlayer insulating film 611a. The power source lines 614 are connected through the contact holes 612b to the drain region 607b.

As shown in FIG. 16, the circuit element portion 602 includes thin-film transistors 615 connected to drive the respective pixel electrodes 613.

The light-emitting element portion 603 includes a functional layers 617 each formed on a corresponding one of pixel electrodes 613, and bank portions 618 which are formed between the pixel electrodes 613 and the functional layers 617 and which are used to partition the functional layers 617 from one another.

The pixel electrodes 613, the functional layers 617, and the cathode 604 formed on the functional layers 617 constitute the light-emitting element. Note that the pixel electrodes 613 are formed into a substantially rectangular shape in plan view by patterning, and the bank portions 618 are formed so that each two of the pixel electrodes 613 sandwich a corresponding one of the bank portions 618.

Each of the bank portions 618 includes an inorganic bank layer 618a (first bank layer) formed of an inorganic material such as SiO, SiO₂, or TiO₂, and an organic bank layer 618b (second bank layer) which is formed on the inorganic bank layer 618a and has a trapezoidal shape in a sectional view. The organic bank layer 618b is formed of a resist, such as an acrylic resin or a polyimide resin, which has an excellent heat resistance and an excellent lyophobic characteristic. A part of each of the bank portions 618 overlaps peripheries of corresponding two of the pixel electrodes 613 which sandwich each of the bank portions 618.

Openings 619 are formed between the bank portions 618 so as to gradually increase in size upwardly against the pixel electrodes 613.

Each of the functional layers 617 includes a positive-hole injection/transport layer 617a formed so as to be laminated on the pixel electrodes 613 and a light-emitting layer 617b formed on the positive-hole injection/transport layer 617a. Note that another functional layer having another function may be arranged so as to be arranged adjacent to the light-emitting layer 617b. For example, an electronic transport layer may be formed.

The positive-hole injection/transport layer 617a transports positive holes from a corresponding one of the pixel electrodes 613 and injects the transported positive holes to the light-emitting layer 617b. The positive-hole injection/transport layer 617a is formed by ejection of a first composition (functional liquid) including a positive-hole injection/transport layer forming material. The positive-hole injection/transport layer forming material may be a known material.

The light-emitting layer 617b is used for emission of light having colors red (R), green (G), or blue (B), and is formed by ejection of a second composition (functional liquid) including a material for forming the light-emitting layer 617b (light-emitting material). As a solvent of the second composition (nonpolar solvent), a known material which is insoluble to the positive-hole injection/transport layer 617a is preferably used. Since such a nonpolar solvent is used as the second composition of the light-emitting layer 617b, the light-emitting layer 617b can be formed without dissolving the positive-hole injection/transport layer 617a again.

The light-emitting layer 617b is configured such that the positive holes injected from the positive-hole injection/transport layer 617a and electrons injected from the cathode 604 are recombined in the light-emitting layer 617b so as to emit light.

The cathode 604 is formed so as to cover an entire surface of the light-emitting element portion 603, and in combination with the pixel electrodes 613, supplies current to the functional layers 617. Note that a sealing member (not shown) is arranged on the cathode 604.

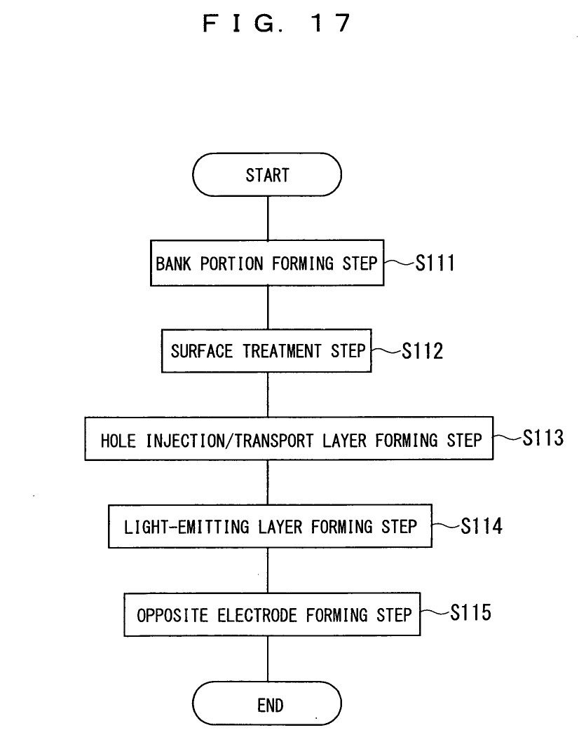

Steps of manufacturing the display apparatus 600 will now be described with reference to FIGS. 17 to 25.

As shown in FIG. 17, the display apparatus 600 is manufactured through a bank portion forming step (S111), a surface processing step (S112), a positive-hole injection/transport layer forming step (S113), a light-emitting layer forming step (S114), and a counter electrode forming step (S115). Note that the manufacturing steps are not limited to these examples shown in FIG. 17, and one of these steps may be omitted or another step may be added according as desired.

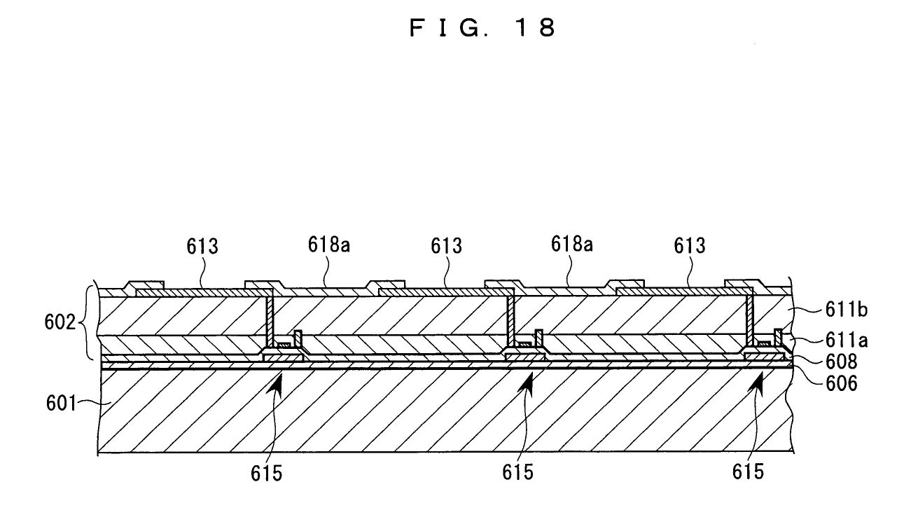

In the bank portion forming step (S111), as shown in FIG. 18, the inorganic bank layers 618a are formed on the second interlayer insulating film 611b. The inorganic bank layers 618a are formed by forming an inorganic film at a desired position and by patterning the inorganic film by the photolithography technique. At this time, a part of each of the inorganic bank layers 618a overlaps peripheries of corresponding two of the pixel electrodes 613 which sandwich each of the inorganic bank layers 618a.

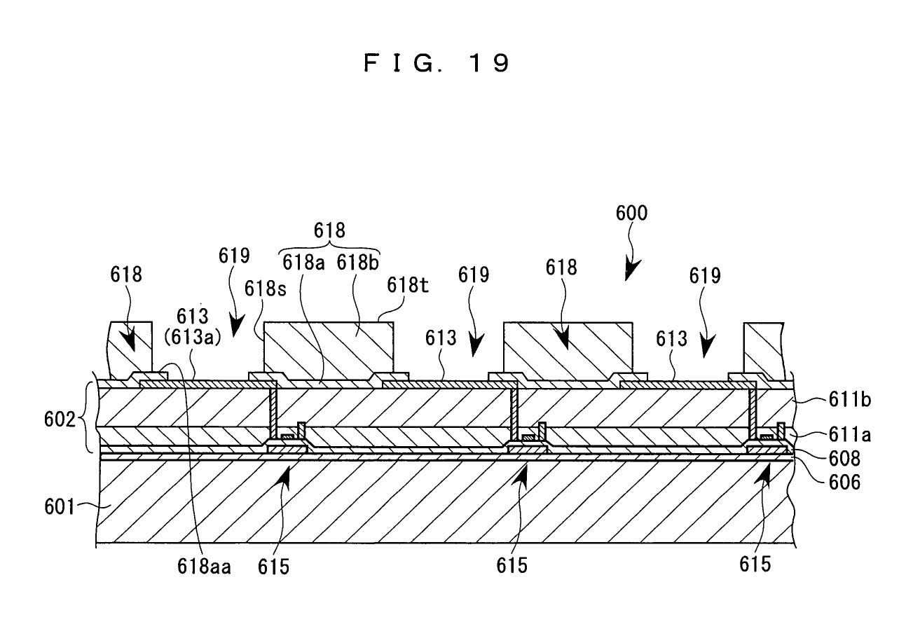

After the inorganic bank layers 618a are formed, as shown in FIG. 19, the organic bank layers 618b are formed on the inorganic bank layers 618a. As with the inorganic bank layers 618a, the organic bank layers 618b are formed by patterning a formed organic film by the photolithography technique.

The bank portions 618 are thus formed. When the bank portions 618 are formed, the openings 619 opening upward relative to the pixel electrodes 613 are formed between the bank portions 618. The openings 619 define pixel areas.

In the surface processing step (S112), a hydrophilic treatment and a repellency treatment are performed. The hydrophilic treatment is performed on first lamination areas 618aa of the inorganic bank layers 618a and electrode surfaces 613a of the pixel electrodes 613. The hydrophilic treatment is performed, for example, by plasma processing using oxide as a processing gas on surfaces of the first lamination areas 618aa and the electrode surfaces 613a to have hydrophilic properties. By performing the plasma processing, the ITO forming the pixel electrodes 613 is cleaned.

The repellency treatment is performed on walls 618s of the organic bank layers 618b and upper surfaces 618t of the organic bank layers 618b. The repellency treatment is performed as a fluorination treatment, for example, by plasma processing using tetrafluoromethane as a processing gas on the walls 618s and the upper surfaces 618t.

By performing this surface processing step, when the functional layers 617 is formed using the functional liquid droplet ejection heads 17, the functional liquid droplets are ejected onto the pixel areas with high accuracy. Furthermore, the functional liquid droplets attached onto the pixel areas are prevented from flowing out of the openings 619.

A display apparatus body 600A is obtained through these steps. The display apparatus body 600A is mounted on the set table 21 of the liquid droplet ejection apparatus 1 shown in FIG. 1 and the positive-hole injection/transport layer forming step (S113) and the light-emitting layer forming step (S114) are performed thereon.

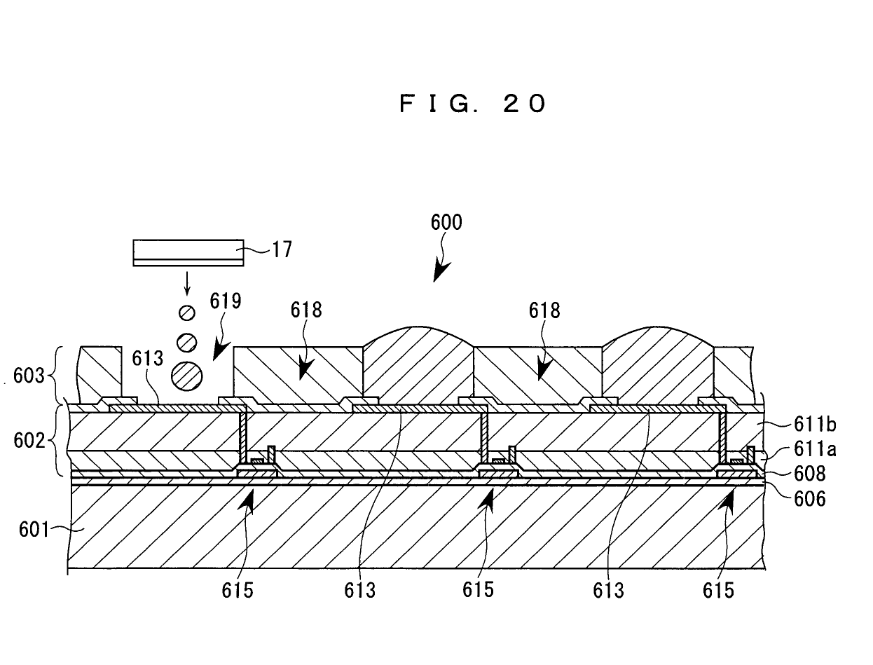

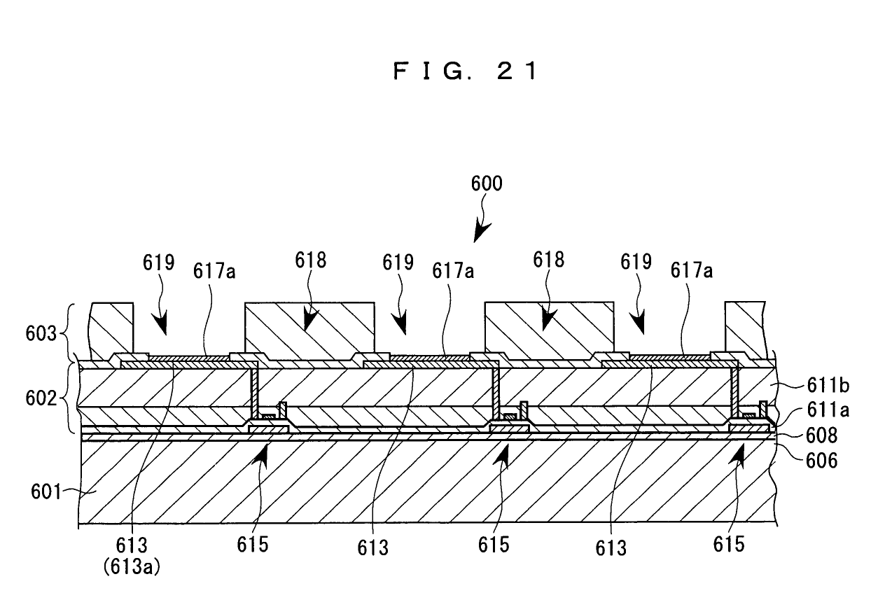

As shown in FIG. 20, in the positive-hole injection/transport layer forming step (S113), the first compositions including the material for forming a positive-hole injection/transport layer are ejected from the functional liquid droplet ejection heads 17 into the openings 619 included in the pixel areas. Thereafter, as shown in FIG. 21, drying processing and a thermal treatment are performed to evaporate polar solution included in the first composition whereby the positive-hole injection/transport layers 617a are formed on the pixel electrodes 613 (electrode surface 613a).

The light-emitting layer forming step (S114) will now be described. In the light-emitting layer forming step, as described above, a nonpolar solvent which is insoluble to the positive-hole injection/transport layers 617a is used as the solvent of the second composition used at the time of forming the light-emitting layer in order to prevent the positive-hole injection/transport layers 617a from being dissolved again.

On the other hand, since each of the positive-hole injection/transport layers 617a has low affinity to a nonpolar solvent, even when the second composition including the nonpolar solvent is ejected onto the positive-hole injection/transport layers 617a, the positive-hole injection/transport layers 617a may not be brought into tight contact with the light-emitting layers 617b or the light-emitting layers 617b may not be uniformly applied.

Accordingly, before the light-emitting layers 617b are formed, surface processing (surface improvement processing) is preferably performed so that each of the positive-hole injection/transport layers 617a has high affinity to the nonpolar solvent and to the material for forming the light-emitting layers. The surface processing is performed by applying a solvent the same as or similar to the nonpolar solvent of the second composition used at the time of forming the light-emitting layers on the positive-hole injection/transport layers 617a and by drying the applied solvent.

Employment of this surface processing allows the surface of the positive-hole injection/transport layers 617a to have high affinity to the nonpolar solvent, and therefore, the second composition including the material for forming the light-emitting layers can be uniformly applied to the positive-hole injection/transport layers 617a in the subsequent step.

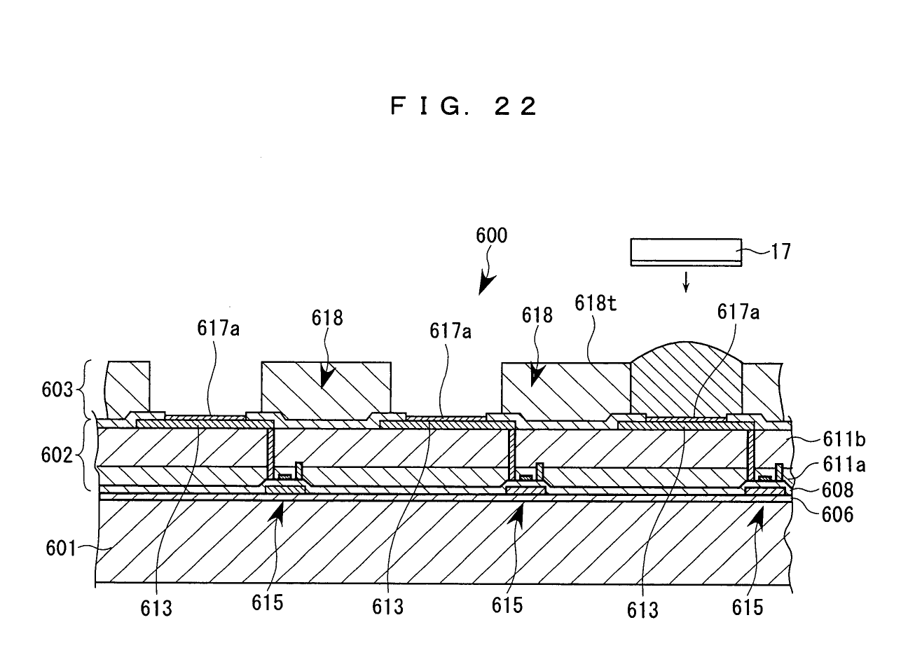

As shown in FIG. 22, a predetermined amount of second composition including the material for forming the light-emission layers of one of the three colors (blue color (B) in an example of FIG. 22) is ejected into the pixel areas (openings 619) as functional liquid. The second composition ejected into the pixel areas spreads over the positive-hole injection/transport layer 617a and fills the openings 619. Note that, even if the second composition is ejected and attached to the upper surfaces 618t of the bank portions 618 which are outside of the pixel area, since the repellency treatment has been performed on the upper surfaces 618t as described above, the second component easily drops into the openings 619.

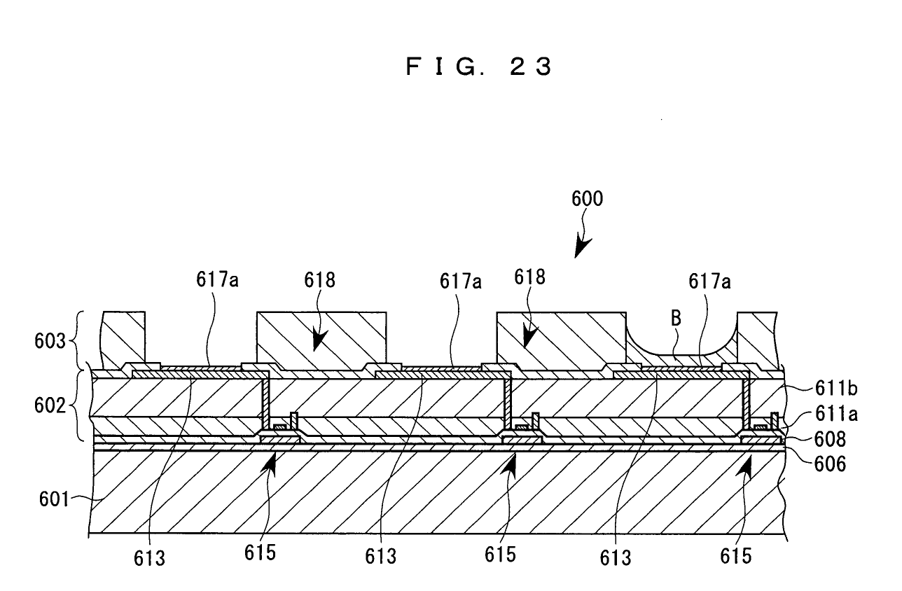

Thereafter, the drying processing is performed so that the ejected second composition is dried and the nonpolar solvent included in the second composition is evaporated whereby the light-emitting layers 617b are formed on the positive-hole injection/transport layers 617a as shown in FIG. 23. In FIG. 23, one of the light-emitting layers 617b corresponding to the blue color (B) is formed.

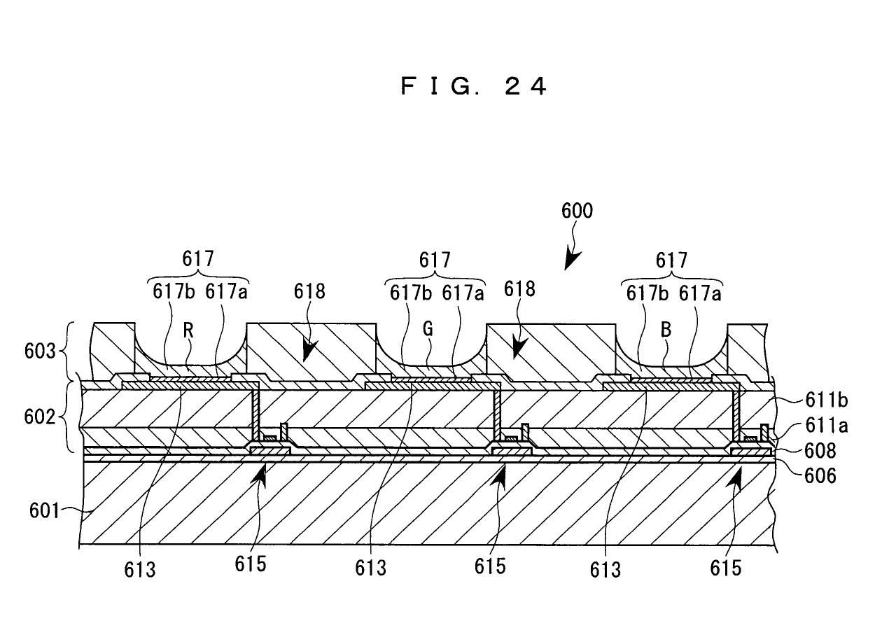

Similarly, as shown in FIG. 24, a step similar to the above-described step of forming the light-emitting layers 617b corresponding to the blue color (B) is repeatedly performed by using functional liquid droplet ejection heads 17 so that the light-emitting layers 617b corresponding to other colors (red (R) and green (G)) are formed. Note that the order of formation of the light-emitting layers 617b is not limited to the order described above as an example, and any other orders may be applicable. For example, an order of forming the light-emitting layers 617b may be determined in accordance with a light-emitting layer forming material. Furthermore, the color scheme pattern of the three colors R, G, and B may be the tripe arrangement, the mosaic arrangement, or the delta arrangement.

As described above, the functional layers 617, that is, the positive-hole injection/transport layers 617a and the light-emitting layers 617b are formed on the pixel electrodes 613. Then, the process proceeds to the counter electrode forming step (S115).

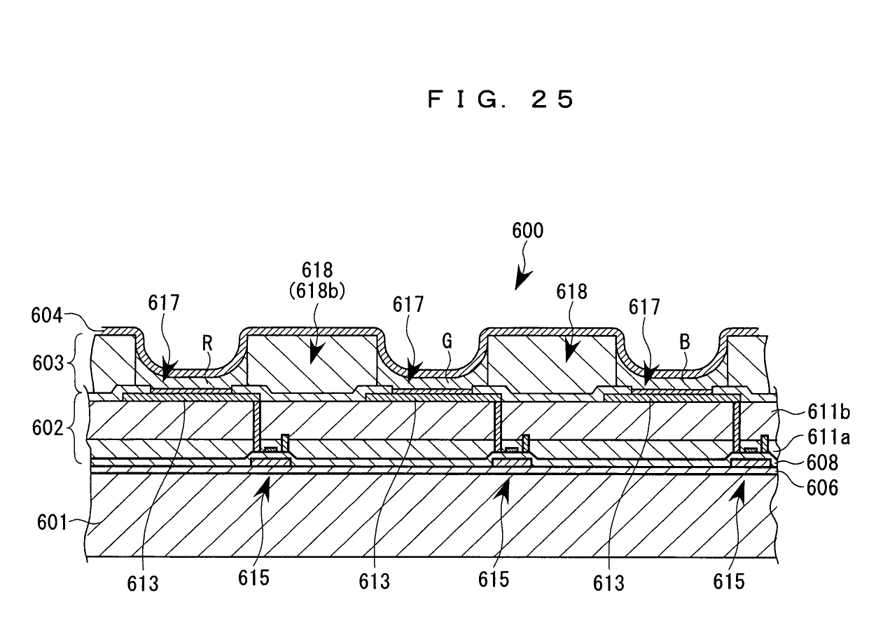

In the counter electrode forming step (S115), as shown in FIG. 25, the cathode (counter electrode) 604 is formed on entire surfaces of the light-emitting layers 617b and the organic bank layers 618b by an evaporation method, sputtering, or a CVD (chemical vapor deposition) method, for example. The cathode 604 is formed by laminating a calcium layer and an aluminum layer, for example, in this embodiment.

An Al film and a Ag film as electrodes and a protective layer formed of SiO₂ or SiN for preventing the Al film and the Ag film from being oxidized are formed on the cathode 604.

After the cathode 604 is thus formed, other processes such as sealing processing of sealing a top surface of the cathode 604 with a sealing member and wiring processing are performed whereby the display apparatus 600 is obtained.

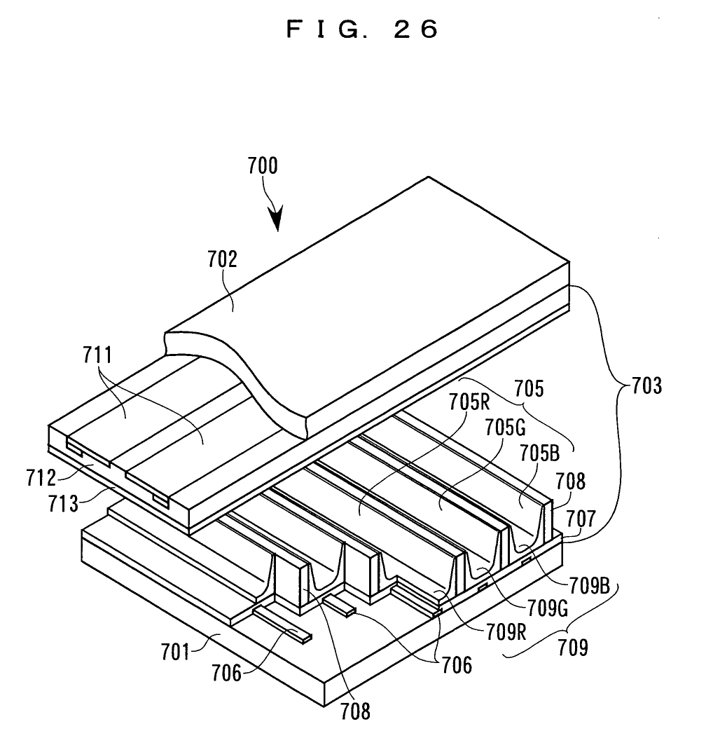

FIG. 26 is an exploded perspective view of an essential part of a plasma display apparatus (PDP apparatus: hereinafter simply referred to as a display apparatus 700). Note that, in FIG. 26, the display apparatus 700 is partly cut away.

The display apparatus 700 includes a first substrate 701, a second substrate 702 which faces the first substrate 701, and a discharge display portion 703 interposed therebetween. The discharge display portion 703 includes a plurality of discharge chambers 705. The discharge chambers 705 include red discharge chambers 705R, green discharge chambers 705G, and blue discharge chambers 705B, and are arranged so that one of the red discharge chambers 705R, one of the green discharge chambers 705G, and one of the blue discharge chambers 705B constitute one pixel as a group.

Address electrodes 706 are arranged on the first substrate 701 with predetermined intervals therebetween in a stripe pattern, and a dielectric layer 707 is formed so as to cover top surfaces of the address electrodes 706 and the first substrate 701. Partition walls 708 are arranged on the dielectric layer 707 so as to be arranged along with the address electrodes 706 in a standing manner between the adjacent address electrodes 706. Some of the partition walls 708 extend in a width direction of the address electrodes 706 as shown in FIG. 26, and the others (not shown) extend perpendicular to the address electrodes 706.

Regions partitioned by the partition walls 708 serve as the discharge chambers 705.

The discharge chambers 705 include respective fluorescent substances 709. Each of the fluorescent substances 709 emits light having one of the colors of red (R), green (G) and blue (B). The red discharge chamber 705R has a red fluorescent substance 709R on its bottom surface, the green discharge chamber 705G has a green fluorescent substance 709G on its bottom surface, and the blue discharge chamber 705B has a blue fluorescent substance 709B on its bottom surface.

On a lower surface of the second substrate 72 in FIG. 26, a plurality of display electrodes 711 are formed with predetermined intervals therebetween in a stripe manner in a direction perpendicular to the address electrodes 706. A dielectric layer 712 and a protective film 713 formed of MgO, for example, are formed so as to cover the display electrodes 711.

The first substrate 701 and the second substrate 702 are attached so that the address electrodes 706 are arranged perpendicular to the display electrodes 711. Note that the address electrodes 706 and the display electrodes 711 are connected to an alternate power source (not shown).

When the address electrodes 706 and the display electrodes 711 are brought into conduction states, the fluorescent substances 709 are excited and emit light whereby display with colors is achieved.

In this embodiment, the address electrodes 706, the display electrodes 711, and the fluorescent substances 709 may be formed using the liquid droplet ejection apparatus 1 shown in FIG. 1. Steps of forming the address electrodes 706 on the first substrate 701 are described hereinafter.

The steps are performed in a state where the first substrate 701 is mounted on the set table 21 on the liquid droplet ejection apparatus 1.

The functional liquid droplet ejection heads 17 eject a liquid material (functional liquid) including a material for forming a conducting film wiring as functional droplets to be attached onto regions for forming the address electrodes 706. The material for forming a conducting film wiring included in the liquid material is formed by dispersing conductive fine particles such as those of a metal into dispersed media. Examples of the conductive fine particles include a metal fine particle including gold, silver, copper, palladium, or nickel, and a conductive polymer.

When ejection of the liquid material onto all the desired regions for forming the address electrodes 706 is completed, the ejected liquid material is dried, and the disperse media included in the liquid material is evaporated whereby the address electrodes 706 are formed.

Although the steps of forming the address electrodes 706 are described as an example above, the display electrodes 711 and the fluorescent substances 709 may be formed by the steps described above.

In a case where the display electrodes 711 are formed, as with the address electrodes 706, a liquid material (functional liquid) including a material for forming a conducting film wiring is ejected from the functional liquid droplet ejection heads 17 as liquid droplets to be attached to the areas for forming the display electrodes.

In a case where the fluorescent substances 709 are formed, a liquid material including fluorescent materials corresponding to three colors (R, G, and B) is ejected as liquid droplets from the functional liquid droplet ejection heads 17 so that liquid droplets having the three colors (R, G, and B) are attached within the discharge chambers 705.

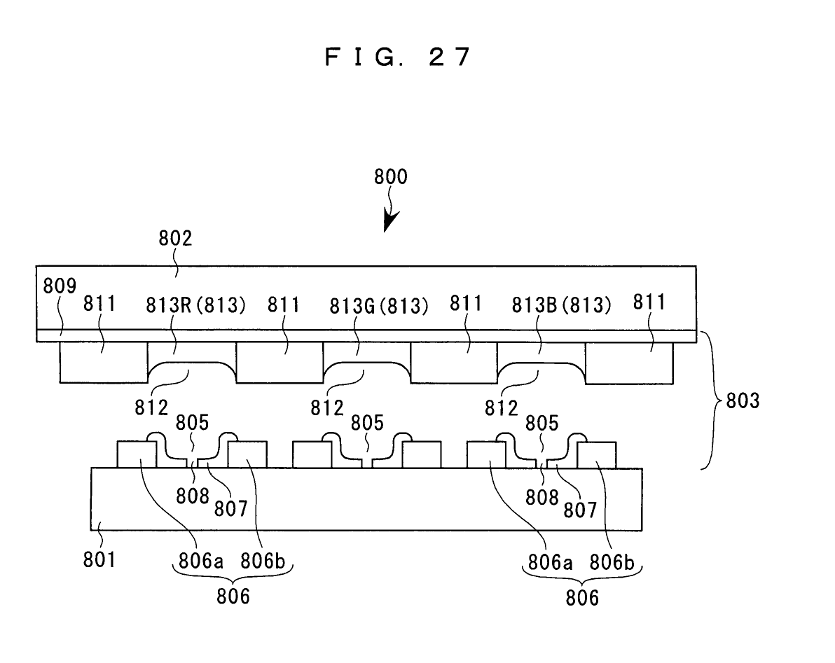

FIG. 27 shows a sectional view of an essential part of an electron emission apparatus (also referred to as a FED apparatus or a SED apparatus: hereinafter simply referred to as a display apparatus 800). In FIG. 27, a part of the display apparatus 800 is shown in the sectional view.

The display apparatus 800 includes a first substrate 801, a second substrate 802 which faces the first substrate 801, and a field-emission display portion 803 interposed therebetween. The field-emission display portion 803 includes a plurality of electron emission portions 805 arranged in a matrix.

First element electrodes 806a and second element electrodes 806b, and conductive films 807 are arranged on the first substrate 801. The first element electrodes 806a and the second element electrodes 806b intersect with each other. Cathode electrodes 806 are formed on the first substrate 801, and each of the cathode electrodes 806 is constituted by one of the first element electrodes 806a and one of the second element electrodes 806b. In each of the cathode electrodes 806, one of the conductive films 807 having a gap 808 is formed in a portion formed by the first element electrode 806a and the second element electrode 806b. That is, the first element electrodes 806a, the second element electrodes 806b, and the conductive films 807 constitute the plurality of electron emission portions 805. Each of the conductive films 807 is constituted by palladium oxide (PdO). In each of the cathode electrodes 806, the gap 808 is formed by forming processing after the corresponding one of the conductive films 807 is formed.

An anode electrode 809 is formed on a lower surface of the second substrate 802 so as to face the cathode electrodes 806. A bank portion 811 is formed on a lower surface of the anode electrode 809 in a lattice. Fluorescent materials 813 are arranged in opening portions 812 which opens downward and which are surrounded by the bank portion 811. The fluorescent materials 813 correspond to the electron emission portions 805. Each of the fluorescent materials 813 emits fluorescent light having one of the three colors, red (R), green (G), and blue (B). Red fluorescent materials 813R, green fluorescent materials 813G, and blue fluorescent materials 813B are arranged in the opening portions 812 in a predetermined arrangement pattern described above.

The first substrate 801 and the second substrate 802 thus configured are attached with each other with a small gap therebetween. In this display apparatus 800, electrons emitted from the first element electrodes 806a or the second element electrodes 806b included in the cathode electrodes 806 hit the fluorescent materials 813 formed on the anode electrode 809 so that the fluorescent materials 813 are excited and emit light whereby display with colors is achieved.

As with the other embodiments, in this case also, the first element electrodes 806a, the second element electrodes 806b, the conductive films 807, and the anode electrode 809 may be formed using the liquid droplet ejection apparatus 1. In addition, the red fluorescent materials 813R, the green fluorescent materials 813G, and the blue fluorescent materials 813B may be formed using the liquid droplet ejection apparatus 1.

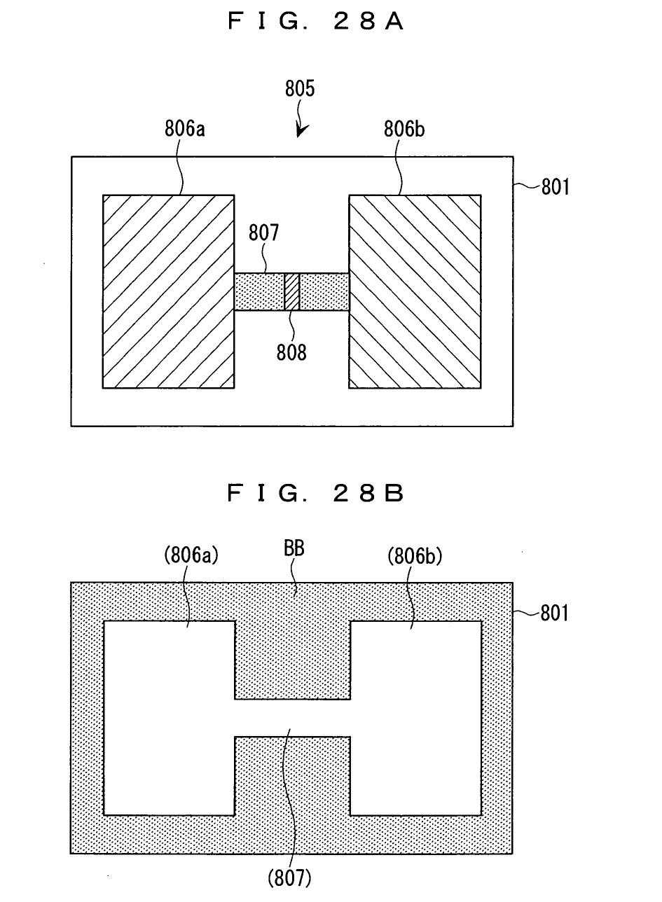

Each of the first element electrodes 806a, each of the second element electrodes 806b, and each of the conductive films 807 have shapes as shown in FIG. 28A. When the first element electrodes 806a, the second element electrodes 806b, and the conductive films 807 are formed, portions for forming the first element electrodes 806a, the second element electrodes 806b, and the conductive films 807 are left as they are on the first substrate 801 and only bank portions BB are formed (by a photolithography method) as shown in FIG. 28B. Then, the first element electrodes 806a and the second element electrodes 806b are formed by an inkjet method using a solvent ejected from the liquid droplet ejection apparatus 1 in grooves defined by the bank portions BB and are formed by drying the solvent. Thereafter, the conductive films 807 are formed by the inkjet method using the liquid droplet ejection apparatus 1. After forming the conductive films 807, the bank portions BB are removed by ashing processing and the forming processing is performed. Note that, as with the case of the organic EL device, the hydrophilic treatment is preferably performed on the first substrate 801 and the second substrate 802 and the repellency treatment is preferably performed on the bank portion 811 and the bank portions BB.

Examples of other electro-optical apparatuses include an apparatus for forming metal wiring, an apparatus for forming a lens, an apparatus for forming a resist, and an apparatus for forming an optical diffusion body. Use of the liquid droplet ejection apparatus 1 makes it possible to efficiently manufacture various electro-optical apparatuses.

What is claimed is:

1. A functional liquid supplying apparatus comprising:
a plurality of sub-tanks which supply functional liquid through head-side channels to a plurality of inkjet functional liquid droplet ejection heads;
a main tank which supplies the functional liquid to the plurality of sub-tanks by applying a pressure;
a functional liquid channel including a main channel connected to the main tank at an upstream end thereof, a branched channel connected to the main channel at an upstream end thereof, and a plurality of branch channels connected to the branched channel at upstream ends thereof and connected to the corresponding sub-tanks at downstream ends thereof;
a buffer tank arranged in the main channel;
an auxiliary pressure applying unit which is used to supply the functional liquid in the buffer tank to the sub-tanks by applying a pressure when the main tank is changed to a new one; and
a plurality of branch channel opening units which are disposed in the respective branch channels and which supply the functional liquid supplied by applying a pressure from the main tank or the buffer tank to the sub-tanks by performing opening/closing operations.

2. The functional liquid supplying apparatus according to claim 1,
wherein the branch channel opening units are air-operated valves openable and closable without volumetric changes of the branch channels.

3. The functional liquid supplying apparatus according to claim 1,
wherein the sub-tanks are disposed in positions higher than the corresponding functional liquid droplet ejection heads,
pressure reducing valves which operate in accordance with an atmospheric pressure and which maintain hydraulic head values between the pressure reducing valves and the functional liquid droplet ejection heads within a predetermined allowable range are arranged in the respective head-side channels, and
negative pressure controllers which maintain hydraulic head values between the negative pressure controllers and the corresponding pressure reducing valves within a predetermined allowable range are connected to the sub-tanks.

4. The functional liquid supplying apparatus according to claim 1, further comprising:
liquid level controllers which control levels of liquid to stay around intermediate portions of the sub-tanks when the functional liquid is supplied to the sub-tanks.

5. The functional liquid supplying apparatus according to claim 1, further comprising:
a bubble removing unit which is disposed in the main channel and which removes microbubbles from the functional liquid.

6. The functional liquid supplying apparatus according to claim 1, further comprising:
an air releasing unit disposed at a downstream end of the main channel; and
an air releasing channel connected to the air releasing unit.

7. The functional liquid supplying apparatus according to claim 1, further comprising:
sub pressure units which are connected to the sub-tanks and which apply pressures to the sub-tanks;
head channel opening units which disposed in the head-side channels and which open and close the head-side channels;
upper limit detectors which detect levels of liquid which have reached upper limits of the sub-tanks; and
liquid supply controllers which control the sub pressure units, the branch channel opening units, and the head channel opening units,
wherein when the upper limit detectors detect the levels of liquid which has reached the upper limits of the sub-tanks, the liquid supply controllers open the branch channel opening units and close the head channel opening units, and thereafter, drive the sub pressure units so that the functional liquid included in the sub-tanks are reversely supplied to the buffer tank.

8. The functional liquid supplying apparatus according to claim 1,
wherein the branched channel is configured such that, a channel is repeatedly divided into two channels in a plurality of stages from an upstream end thereof to a downstream end thereof using branched joints and pairs of connection short tubes, and is disposed such that the upstream end thereof is positioned in a lower side and the downstream end thereof is positioned in an upper side.

9. The functional liquid supplying apparatus according to claim 8,
wherein when a branched channel, the number of ends of which is not any power of two in a most downstream stage is employed, pressure losses are controlled by controlling lengths of the pairs of connection short tubes in the most downstream stage and the pairs of connection short tubes in a stage one stage higher than the most downstream stage.

10. The functional liquid supplying apparatus according to claim 8,
wherein in the branched channel, among the branched joints and the pairs of connection short tubes, branched joints and pairs of connection short tubes in the most upstream stage have diameters larger than at least those of branched joints and pairs of connection short tubes in the most downstream stage.

11. The functional liquid supplying apparatus according to claim 8, wherein the branched joints are T-shaped joints.

12. A liquid droplet ejection apparatus, comprising:
a plotting unit which performs a plotting process by ejecting functional liquid droplets from inkjet functional liquid droplet ejection heads while the inkjet functional liquid droplet ejection heads are moved; and
the functional liquid supplying apparatus set forth in claim 1 which supplies functional liquid to the functional liquid droplet ejection heads.

13. The droplet ejection apparatus according to claim 12, further comprising:
a chamber unit configured to control inner atmosphere at a predetermined temperature,
wherein the chamber unit accommodates the plotting unit and further accommodates the functional liquid supply apparatus but does not accommodate the main tank which is arranged outside the chamber unit.

14. A method for manufacturing an electro-optical apparatus,
wherein a film formation portion is formed on a workpiece by functional liquid droplets using the functional liquid droplet ejection apparatus set forth in claim 12.

15. An electro-optical apparatus in which a film formation portion is formed on a workpiece by functional liquid droplets using the functional liquid droplet ejection apparatus set forth in claim 12.

16. An electronic apparatus provided with the electro-optical apparatus manufactured by the method for manufacturing an electro-optical apparatus set forth in claim 14.
